(19) United States
(12) Patent Application Publication
(10) Pub. No.: US 2002/0178017 A1
(43) Pub. Date: Nov. 28, 2002

(54) Financial excellence indicator system of Texas - information about education resources (FEISTIER)

(76) Inventors: John H. Stevens, Austin, TX (US); Thomas Dawson Canby JR., Austin, TX (US)

Correspondence Address: AKIN, GUMP, STRAUSS, HAUER & FELD, L.L.P., 300 WEST 6TH STREET, SUITE 2100, AUSTIN, TX, 78701, US

(21) Appl. No.: 09/866,140

(22) Filed: May 25, 2001

(51) Int. Cl. G06F 17/60

(52) U.S. Cl. 705/1

(57) ABSTRACT

An excellence indicator system. The invention provides for information about education resources. The invention is generically referred to with the acronym FEISTIER. The invention allows for the information integration from among numerous school districts, campuses, and other public educational divisions into a single report. The single report is, in some embodiments, a multi-dimensional report allowing a user to acquire a host of information for direction and guidance in performing management of the financial resources within the public educational division. For example, a school district manager may use the functionality of FEISTIER to perform comparative analysis of his/her school district in view of other school districts. Moreover, the comparison may be further culled to include only actually comparable school districts, bases on parameter including income, size and social factors. In addition, the FEISTIER database allows user to perform extensive data mining that was absolutely inconceivable using conventional systems.

### BACKGROUND

1. Technical Field

The present invention relates generally to business management systems; and, more particularly, it relates to a system that is operable to assist in the management of resources to be used within educational school systems based upon a variety of inputs.

2. Related Art

Within the context of management of public school systems, there is very little guidance that may be offered to a manager that will assist in resource allocation. Whether the manager is of a campus, a district, or even larger or smaller divisions within the school system, the manager is typically left to his own experience and judgment regarding much of the management of resources (including financial resources) under his/her control. What typically occurs in the context of a change of administration, the new manager is oftentimes left to survive in the wake of the preceding administration for some time before any intelligent or rational analysis may be made. That is to say, there exists no mechanism through which the new manager may make immediate and efficient allocation of resources.

While the difficulties are exceedingly great at smaller division levels, such as within campuses, the problem can even be greater within larger division levels such as district level positions and large department levels. There does not exist in the conventional art the means by which the data for a large number of entities may be integrated into a single resource that may be used at the various levels within the system. For example, within the context of a state-wide public school system, though often viewed as being “integrated” in terms organization, there is nevertheless a radical deficiency regarding the integration of information from among the various divisions into a format that is both user-friendly and useful regarding resource management and allocation. The individuals who are held accountable to perform administrative functions within this state-wide public system are often held to very high standards and are given very little support from the state to meet those standards; there is little assistance given to them in terms of guidance.

Further limitations and disadvantages of conventional and traditional systems will become apparent to one of skill in the art through comparison of such systems with the present invention as set forth in the remainder of the present application with reference to the drawings.

### SUMMARY OF THE INVENTION

Various aspects of the present invention can be found in an excellence indicator system. The excellence indicator system includes an excellence indicator system database, a processing circuitry, and a user interface. The excellence indicator system database includes information concerning resource allocation that is performed by a number of entities and also indicia of the performance of those entities. The processing circuitry is operable to perform selective processing of the information contained within the excellence indicator system database. That selective processing includes integrating indicia of performance of at least one of the entities and resource allocation of the at least one of the entities. The user interface allows interaction between a user and the excellence indicator system database. The processing circuitry generates an analysis report that provides any number of various types of information. The information may include an assessment of financial well-being of the at least one entity, a relation of the at least one entity's performance based on costs incurred by the at least one entity, and/or an assessment of the allocation of resources by the at least one entity.

In certain embodiments of the invention, the indicia of performance of the at least one of the entities includes indicia of academic performance. The entities comprises may include one or both or a school district and/or a school campus. The excellence indicator system may also include a cognitive search engine such that the cognitive search engine operates cooperatively with the processing circuitry to perform the selective processing, and the selective processing involves identifying at least two comparable entities and performing comparative analysis of them. The excellence indicator system may also include a cognitive search engine. The excellence indicator system operates such that a user selects an entity for analysis, and the cognitive search engine operates cooperatively with the processing circuitry to perform the selective processing that involves identifying an entity comparable to the user-selected entity. Then, the processing circuitry uses the user-selected entity and the cognitive search engine-identified entity for comparative analysis. The entities may also include a number of one or both a number of school districts and a number of school campuses. The selective processing may involve identifying comparable school campuses when the comparable school campuses are located within comparable school districts such that the comparable school campuses are selected from the number of school campuses, and the comparable school districts are selected from the number of school districts. The analysis report may take on many forms including a five-year trend chart and/or a graph. The selective processing performed by the processing circuitry may include any one or a combination of demographic analysis, resource allocation analysis, financial well-being analysis, and performance and costs analysis. The selective processing may further include strength/weakness identification; it may alternatively include identifying related cost factors. The identified related cost factors may be are further filtered based on a number of additional parameters that include geographical proximity. In some embodiments where the excellence indicator system includes a cognitive search engine, the cognitive search engine operates cooperatively with the processing circuitry to perform selection of an entity by using a number of parameters including size, socio-economic factors, taxable value factors, and trend factors.

Various other aspects of the invention may be found in an excellence indicator system. The excellence indicator system includes an excellence indicator system database, a processing circuitry, and a user interface. The excellence indicator system database includes information concerning resource allocation from a number of entities, the information includes a number of socio-economic factors, taxable value factors, and trending factors. The processing circuitry is operable to perform selective processing of information contained within the excellence indicator system database. The selective processing involves integrating performance and resources of at least one entity within the plurality of entities. The user interface that allows interaction between a user and the financial excellence indicator system database. The the processing circuitry generates an analysis report that provides information including any one of or combination of an assessment of financial well-being of the at least one entity, a relation of the at least one entity's performance based on costs incurred by the at least one entity, and an assessment of the allocation of resources by the at least one entity. The analysis report includes a number of factors that are used by the user to assess the management of the at least one entity, and the user performs data mining of at least one of the factors for further assessment of the management of the at least one entity.

In certain embodiments of the invention, the entities include any one or combination of a school district and a school campus, and the excellence indicator system database further includes indicia of academic performance of the at least one entity.

Various other aspects of the invention may be found in a method to perform excellence indication. The method involves selecting an entity to analyze from a number of entities within an excellence indicator system database, selecting an analysis parameter, performing analysis of the selected entity using the selected analysis parameter, and generating an analysis report. The analysis report provides information including any one or combination of financial well-being of the entity, a relation of the entity's performance based on costs incurred by the entity, and an assessment of the allocation of resources by the entity.

In certain embodiments of the invention, the method further involves selecting a comparable entity using a cognitive search engine to perform comparative analysis between the entity selected to be analyzed and the cognitive search engine-selected entity. The method may also further involve providing a parameter to the cognitive search engine to control the selection of the comparable entity using the cognitive search engine. The entities include any one or combination of a number of school districts and a number of school campuses; the method may then also involve identifying comparable school campuses when the comparable school campuses are located within comparable school districts such that the comparable school campuses are selected from the number of school campuses, and the comparable school districts are selected from the number of school districts. The cognitive search engine operates cooperatively with a processing circuitry to perform selection of an entity by using a number of parameters including size, socio-economic factors, taxable value factors, and trend factors. The method may also involve performing any one or any combination of demographic analysis, resource allocation analysis, financial well being analysis, and/or performance and costs analysis.

Other aspects, advantages and novel features of the present invention will become apparent from the following detailed description of the invention when considered in conjunction with the accompanying drawings.

### BRIEF DESCRIPTION OF THE DRAWINGS

A better understanding of the invention can be obtained when the following detailed description of various exemplary embodiments is considered in conjunction with the following drawings.

FIG. 1 is a system diagram illustrating an overview of the FEISTIER system.

FIG. 2 is a system diagram illustrating an embodiment of a FEISTIER system built in accordance with certain aspects of the invention.

FIG. 3 is a functional diagram illustrating an embodiment of FEISTIER database generation that is performed using certain aspects of the invention.

FIG. 4 is a functional diagram illustrating an embodiment of FEISTIER system operation performed in accordance with certain aspects of the invention.

FIG. 5 is a functional diagram illustrating an embodiment of comparable district identification that is performed using certain aspects of the invention.

FIG. 6 is a functional diagram illustrating an embodiment of comparable campus identification that is performed using certain aspects of the invention.

FIG. 7 is a functional diagram illustrating an embodiment of related cost factor identification and grouping that is performed using certain aspects of the invention.

FIG. 8 is a functional block diagram illustrating an embodiment of a FEISTIER method that is performed in accordance with certain aspects of the invention.

FIG. 9 is a functional block diagram illustrating another embodiment of a FEISTIER method that is performed in accordance with certain aspects of the invention.

FIG. 10 is a descriptive diagram illustrating an embodiment of a FEISTIER initial interface that is constructed in accordance with certain aspects of the invention.

FIG. 11 is a descriptive diagram illustrating an embodiment of a FEISTIER interface that permits analysis on a per district basis in accordance with certain aspects of the invention.

FIG. 12 is a schematic diagram illustrating an embodiment of a FEISTIER interface that permits district selection in accordance with certain aspects of the invention.

FIG. 13 is a schematic diagram illustrating an embodiment of a FEISTIER interface that permits analysis on a per campus basis in accordance with certain aspects of the invention.

FIG. 14 is a schematic diagram illustrating an embodiment of a FEISTIER interface that permits campus selection in accordance with certain aspects of the invention.

FIG. 15 is a diagram illustrating a five-year trend chart, output by the FEISTIER system, that provides information indicative of unfavorable financial management.

FIG. 16 is a diagram illustrating another five-year trend chart, output by the FEISTIER system, that provides information indicative of unfavorable financial management.

FIG. 17 is a diagram illustrating another five-year trend chart, output by the FEISTIER system, that provides information indicative of unfavorable financial management.

FIG. 18 is a schematic diagram illustrating an embodiment of a FEISTIER interface that permits financial well being analysis in accordance with certain aspects of the invention.

FIG. 19 is a diagram illustrating an embodiment of chart form output of a district rating system that is provided by the FEISTIER system.

FIG. 20 is a diagram illustrating another embodiment of report form output 2000 of a district rating system that is provided by the FEISTIER system.

FIG. 21 is a diagram illustrating an embodiment of district performance information output provided by the FEISTIER system.

FIG. 22 is a diagram illustrating another embodiment of district performance information output provided by the FEISTIER system.

FIG. 23 is a schematic diagram illustrating an embodiment of a FEISTIER interface that permits five-year trend chart data selection in accordance with certain aspects of the invention.

FIG. 24 is a schematic diagram illustrating an embodiment of a FEISTIER interface that permits data category selection from the Academic Excellence Indicator System (AEIS) in accordance with certain aspects of the invention.

FIG. 25 is a schematic diagram illustrating an embodiment of a FEISTIER interface that permits five-year trend chart selection in accordance with certain aspects of the invention.

FIG. 26 is a diagram illustrating another five-year trend chart, output by the FEISTIER system, that shows the extensive data mining functionality offered within various aspects of the invention.

FIG. 27 is a schematic diagram illustrating an embodiment of a performance analysis interface that is constructed in accordance with certain aspects of the invention.

FIG. 28 is a diagram illustrating a five-year trend chart, output by the FEISTIER system, that provides information indicative of favorable financial management.

FIG. 29 is a diagram illustrating another five-year trend chart, output by the FEISTIER system, that provides information indicative of favorable financial management.

FIG. 30 is a diagram illustrating another five-year trend chart, output by the FEISTIER system, that provides information indicative of favorable financial management.

FIG. 31 is a diagram illustrating another five-year trend chart, output by the FEISTIER system, that provides information indicative of favorable financial management.

FIG. 32 is a diagram illustrating another five-year trend chart, output by the FEISTIER system, that provides information indicative of favorable financial management.

FIG. 33 is a diagram illustrating another five-year trend chart, output by the FEISTIER system, that provides information indicative of favorable financial management.

FIG. 34 is a diagram illustrating another five-year trend chart, output by the FEISTIER system, that provides information indicative of favorable financial management.

### DETAILED DESCRIPTION OF THE INVENTION

There has been a movement within the public school systems, beginning perhaps within the state of Texas, towards demanding both academic and fiscal accountability. The various functionality offered within the existing system is extendable to other the educational institutions of other states, and it may also be extended also to non-educational institutions as well. Any system desiring the integration of a vast amount of information, from multiple sources, may benefit from the operation of certain aspects of the invention. The invention has been a first development of a system that will allow those involved within the educational systems to achieve precisely these goals. With a mind always towards fiscal accountability, based on the continually tightening of budgets and funding dedicated towards public school systems, the invention allows for a system that ensures accountability based on any number of parameters including income, size and social factors of the division under consideration.

The invention is also geared to address the previously vacant arena of providing support for the management of divisions within the public school systems, including at the school district level, campus level, and/or department level. The divisions and departments of the public school system include any of those divisions and departments known in the art including divisions based on K-12, kindergarten, elementary school, junior high school, high school, and other divisions and departments of the public school system. If desired, analysis may be performed using only one particular sub-division of these mentioned divisions, e.g., looking only at the 3^{rd} grade. This analysis may be further honed to include only 3^{rd} grades that are situated within comparable school campuses, such as those being 1-6, or K-6; alternatively, it may be further honed to include only 3^{rd} grades within comparable school districts while also including the characteristics of the campus in which the 3^{rd} grade resides. An example of one type of department may include the food services department. While such a department is somewhat de-coupled from the in-class instruction, it is nevertheless extremely coupled to the performance of the school district and/or campus and may also affect the financial well-being of the school district and/or campus in a very large manner.

The use of the 3^{rd} grade and the food services department are merely exemplary for illustration. Any other division or department may also be used as well. The analysis may be used to exclude those campuses in non-comparable districts as well.

It is also noted that the invention is operable to allow for assistance within resource management and allocation at all other levels within the public school systems, including the state and district levels. The invention is operable to provide for analysis of the financial well being of a division. This analysis may be in terms of growth, decline, and trends of these and other parameters.

The invention also provides for extensive data mining and the tying together of many previously non-integrated public databases. The database is arranged in such a way as to provide relatively easy access to the information contained within these various public databases, as well as providing a means by which to synthesize, again with relative ease, selected portions of each of the various public databases. For example, data may be imported from a multitude of sources. Examples of some of the sources from which data may be imported include the Public Education Information Management System (PEIMS), the Academic Excellence Indicator System (AEIS), the exam results from the Texas Assessment of Academic Skills (TAAS) tests, annual financial (audit) reports, accountability ratings, and other data sources as well. The FEISTIER system is operable to process data from these different sources to produce a wide variety of charts, tables, and reports that may be used to evaluate overall performance and management.

One embodiment employs a fixed database that is created at a fixed period of time. If desired, the database is updated again at fixed intervals that are every year in certain embodiments of the invention. The database may be compiled onto a CD-ROM, or other media storage device, for subsequent retrieval and access by user of the FEISTIER functionality offered using various aspects of the invention. Alternatively in other embodiments, the database is linked together via computer network, that is the Internet itself in some embodiments, by which real time updating of the database is made from the various public databases into the FEISTIER database.

In short, the FEISTIER system allows the providing of information regarding performance and resources within the public school systems. It is also noted, however, that nonfinancial resources may also be included within the reporting and analysis of the FEISTIER system's operation. The focus in recent times has been on trying to find a way to provide assistance for the management of financial resources, and the invention is certainly adaptable to do so. Yet, the application of the invention may also be extended to non-financial resources as well. For example, the extensive data mining enabled with the invention allows for the inclusion and consideration of the many intangible characteristics that affect public school operations. One such example of this intangible data is the consideration of socio-economic factors that may significantly influence the operation of the school system. These intangible considerations, in addition to the use of hard data, such as dollars spent, within the reporting functionality offers a user the ability to make better decisions regarding the management and resource allocation of the particular division.

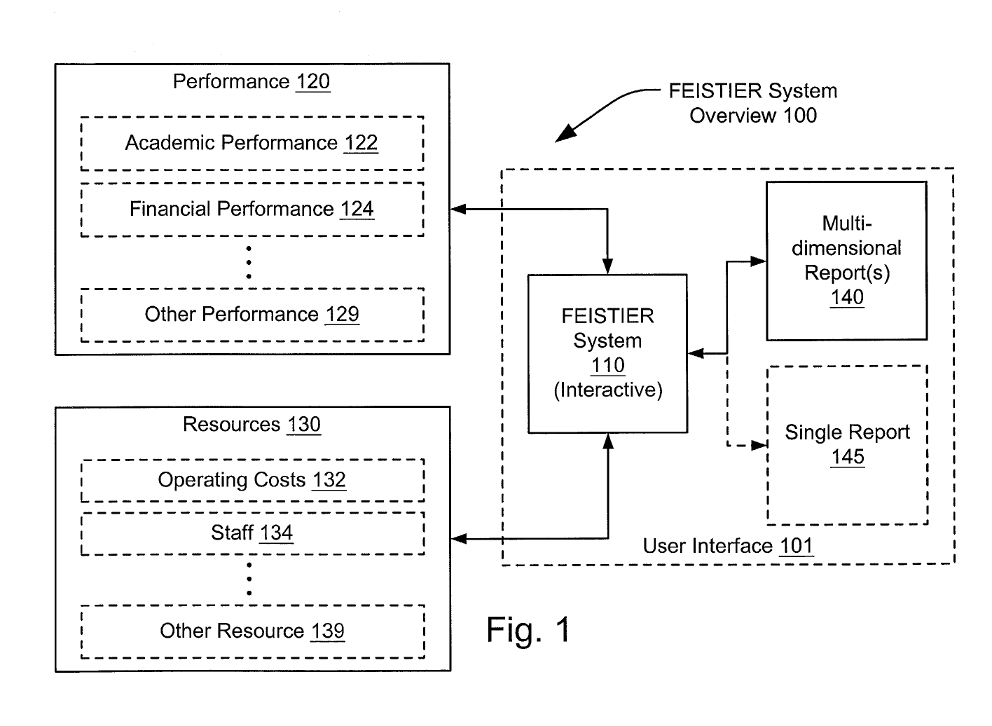

FIG. 1 is a system diagram illustrating an overview 100 of the FEISTIER system 110. From some perspectives, the FEISTIER system 110 is operable to achieve what has been, for many years, unachievable. The FEISTIER system 110 is able to synthesize performance 120 and resources 130 for any of the various entities within an educational system and to generate any number of multi-dimensional report(s) 140. The educational system may include a state-wide educational system. A single report (shown as reference numeral 145), or multiple reports may be included within the multi-dimensional report(s) 140. The general perspective shows the ability of the FEISTIER system 110 to synthesize information from among any number of sources and to generate a means by which a user may intelligently review the performance of the entity within the school system. Again, as will be seen in many of the various embodiments shown below, the entity may be a school campus, a district, or other organizational unit of the school system.

The overview 100 shows the FEISTIER system 110 offering functionality that assists a user of the FEISTIER system 110 to review the performance of the entity within the school system. From certain perspectives, the FEISTIER system 110 allows a user to be de-coupled from any pre-dispositions, opinions, or background-biases that may influence the review of the entity within the school system. As will be seen below, the FEISTIER system 110 is able to present information in such a way as to eliminate these human-effects and to allow for truly objective analysis of the various entities' performances. Moreover, the various embodiments will demonstrate how the FEISTIER system 110 is able to select truly comparable entities for comparison. As is often the case, because of the natural pre-dispositions, opinions, or background-biases of individuals, the ability to select truly comparable entities is often a limitation within human-based analysis. The FEISTIER system 110 provides a way to provide not only guidance to individuals commissioned with the direction of these entities, but it also provides a means by which truly objective analysis may be performed.

From certain perspectives, a user interface 101 allows a user to access the various functionality of the FEISTIER system 110 and to view either the single report 145 of the multi-dimensional report(s) 140. In addition, the user interface may be included within each of the various embodiments allowing a user to direct and select which processing functionality f the FEISTIER system 110 may be desired within a given application.

The performance 120 and the resources 130 may be further sub-categorized to any desired degree of granularity in performing the analysis. For example, the performance 120 may be based on academic performance 122, financial performance 124, . . . and any other parameter providing indicia of performance 129. Similarly, the resources 130 may also may be further sub-categorized to any desired degree of granularity in performing the analysis. For example, the resources 130 may include operating costs 132, staff resources 134, . . . and any other parameter providing indicia of resources 139.

From another perspective, the FEISTIER system 110 shows how a user is provided rational information on which to base decision-making within the management of the entity over which he has been commissioned. User in charge of management of such entities, as described above, are not provided adequate support to assist in their management of the entity. N the public school system context, very high demands are made on managers in terms of their performance and handling of the affairs of their particular sub-division of the public school system, be it a district, a campus, or whatever, and the state (sadly) is ill-equipped to provide adequate support to these individuals. While the expectations are high, the support is relatively low. The FEISTIER system 110 is the first attempt to provide rational information and couple that to the decision-making in an effort to assist these individuals. Three main thrusts of the FEISTIER system 110, as are described in many of the other embodiments below, include an assessment of the financial well-being of the entity, the relation of the entity's performance to cost, and the allocation of resources (both financial and non-financial) in light of that financial well-being and performance.

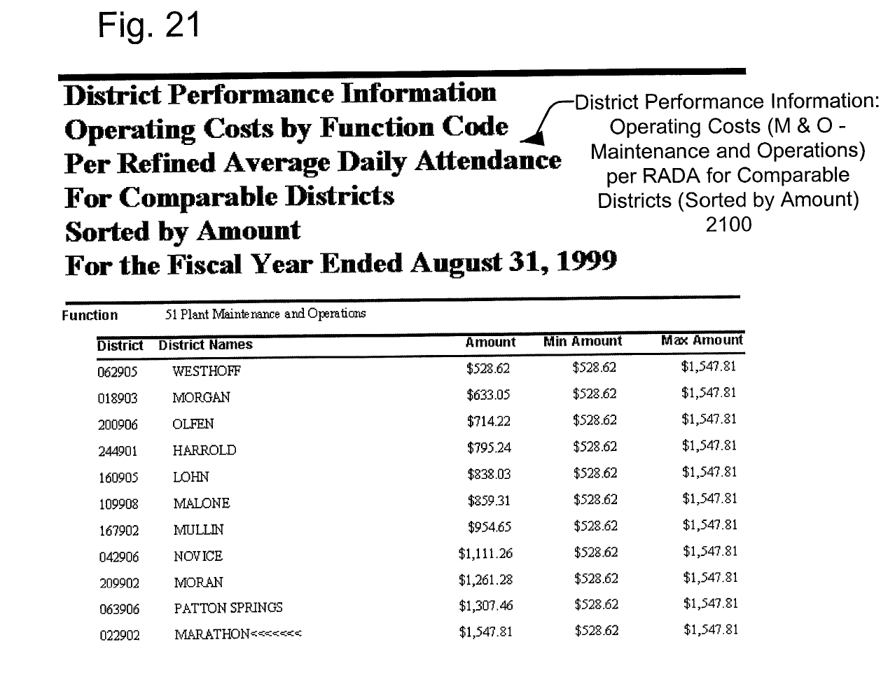

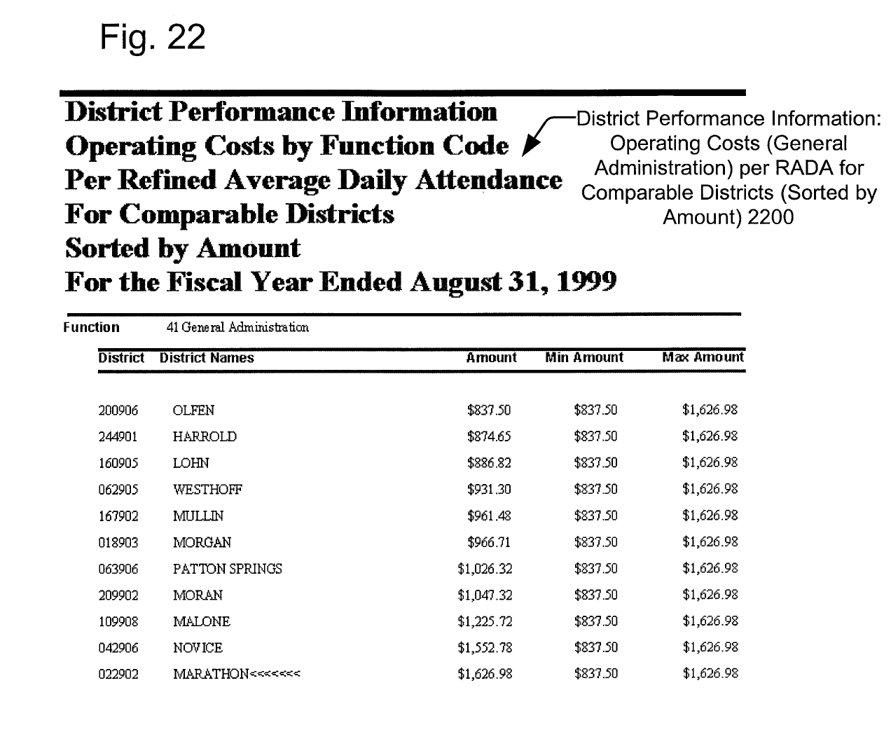

The FEISTIER system 110 is also operable to perform integration of information from any number of databases that operate using standardized accounting and reporting practices with relative ease. While more proprietary forms of accounting and reporting may also be integrated, the FEISTIER system 110 is particularly efficient in integrating many of the systems within the public school system that have, until the advent of FEISTIER system 110, been almost completely de-coupled. The integration of information into the FEISTIER system 110 allows for more rational decision-making, and also allows users to perform data mining to determine and identify the particular parameters that influence the performance and resource allocation of the entities. For example, the FEISTIER system 110 allows a user to drill down, to extremely deep granularity, to clearly identify why a particular trend is trending a certain way. As is shown below in FIGS. 21 and 22, among others, the various components that make up some of the functions (51 for Plant Maintenance and Operations—41 for General Administration) are accessible to the user via the user interface 101. This drilling down is one of the key elements that allows for rational identification of the parameters that affect these trends, and this allows the user to identify, perhaps better than ever before, how to correct for these trends and (ideally) make adequate modification to keep the entity in a sound state of financial well-being.

From certain other perspectives, the FEISTIER system 110 allows for enhancing the resource management of the entity. The information provided to the user by the FEISTIER system 110 is of radically diminished complexity, allowing a much-needed increase in clarity for rational decision-making. The factors provided to the user by the FEISTIER system 110 are quantifiable, and rationally based factors. These factors may be further researched (using various drill down methods) within the scope and spirit of the invention.

The FEISTIER system 110 also provides, for the first time, a uniform and consistent way of presenting data and information to the various managers, administrators, and other commissioned with the management and administration of the various entities. In the context of a state-wide public school system, this is the very first time that the entirety of such individuals are proffered the same information, in the same format; this consistency and uniformity allows greater communication and understanding between these various individuals. The ability to identify comparable entities, as is described also in other of the various embodiments, allows a user to identify the consequences (both good and bad) of past decisions that affect the trends of the various entities.

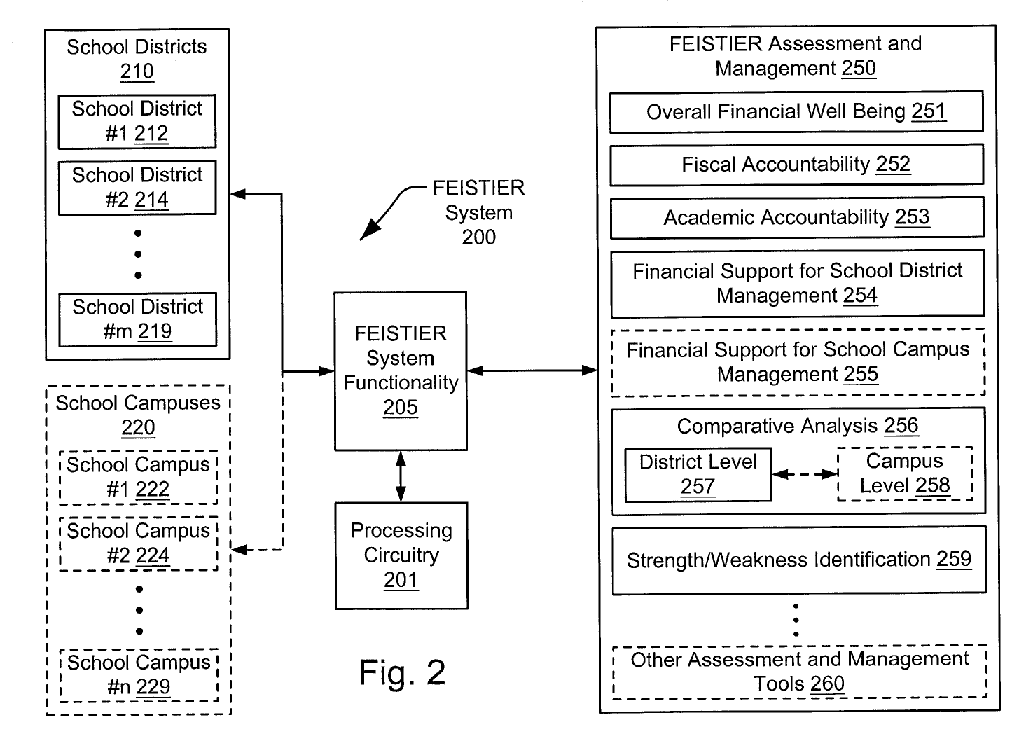

FIG. 2 is a system diagram illustrating an embodiment of a FEISTIER system 200 built in accordance with certain aspects of the invention. The FEISTIER system 200 employs FEISTIER system functionality 205 to incorporate a number of school districts 210 for perform FEISTIER assessment and management 250. The FEISTIER system 200 employs processing circuitry 201 to perform integration and processing of the various functions described herein. The processing circuitry 201 may include a computer or other hardware capable of performing processing in various embodiments of the invention. The number of school districts 210 are shown as a school district #1 212, a school district #2 214, . . . , and a school district #m 219. Information for each of the number of school districts 210 (the school district #1 212, the school district #2 214, . . . , and the school district #m 219) are able to be incorporated into a single usable manner for performing the FEISTIER assessment and management 250.

The FEISTIER assessment and management 250 includes a number of assessment and management functions. For example, overall financial well being 251 may be performed within the FEISTIER assessment and management 250 on a per school district basis or even on a multiple school district basis. This multiple school district basis may include all of the school districts within the number of school districts 210 or a subset of them. The overall financial well being 251 may include an assessment of the management of resources available with respect to resources incoming. Alternatively, the overall financial well being 251 may also include a snapshot view of the instantaneous overall financial well being 251 of the entity or an analysis of the trend of the overall financial well being 251 for the entity. For example, the FEISTIER assessment and management 250 will help a user to realize that, though an entity may be financially sound at a given instance, the entity may be trending towards financial health or financial sickness.

In addition, the FEISTIER assessment and management 250 also includes fiscal accountability 252. Again, the fiscal accountability 252 may also on a per school district basis or even on a multiple school district basis. The fiscal accountability 252 may include assessment and management of whether the entity is allocating and using the resources in a suitable manner. The FEISTIER assessment and management 250 also includes academic accountability 253. The academic accountability 253 includes assessment and management of whether the entity is performing up to sufficient academic standards. This academic accountability 253 may be extremely tied to analysis of the fiscal accountability 252 in certain embodiments of the invention. For example, differing entities may be performing substantially different in terms of academic performance, but when viewed in terms of their situation (including perhaps the financial situation), that entity may very well be performing adequately or sufficiently.

The FEISTIER assessment and management 250 also includes financial support for school district management 254. As mentioned above, one problem that is not addressed in the prior art is the ability to assist new-coming administrators and managers to an adequate level so that they can begin to be productive immediately during their tenure. The FEISTIER system 200 allows such financial support for school district management 254 to assist such individuals in the management of their school district. This financial support for school district management 254 is any number of different supporting functions, many of which are explained in further detail below.

One effective tool that may be used within the FEISTIER assessment and management 250 is comparative analysis 256. This comparative analysis 256 is performed at any level of the various organization within the school system. For example, the comparative analysis 256 may be performed at a district level 257. Alternatively, it may be performed at a campus level 258. If desired, the analysis may be coupled to include campuses (using the campus level 258) within only comparable school districts (using the district level 257). The use of the district level 257 campus level 258 are exemplary of the levels of organizational division that may be achieved within the comparative analysis 256 within the FEISTIER assessment and management 250. Other levels of comparison may also be performed as well.

The FEISTIER assessment and management 250 is also able to assist in strength/weakness identification 259 at the school district level. This will assist in helping management of the school district allowing focusing on areas that need addressing for correction or helping to identify areas that may be emulated, as reasonably as possible and appropriate, in other school districts. It is also noted that any number of other assessment and management tools 260 may also be included within the FEISTIER assessment and management 250 without departing from the scope and spirit of the invention.

In addition, the FEISTIER system 200 is operable to employ the FEISTIER system functionality 205 to incorporate a number of school campuses 220 for perform FEISTIER assessment and management 250. The number of school campuses 220 are shown as a school campus #1 222, a school campus #2 224, . . . , and a school campus #n 229. Information for each of the number of school campuses 220 (the school campus #1 222, the school campus #2 224, . . . and the school campus #n 229) are able to be incorporated into a single usable manner for performing the FEISTIER assessment and management 250. As shown in this embodiment, the FEISTIER assessment and management 250 is able to provide financial support for school campus management 255. Any of the other tools within the FEISTIER assessment and management 250 may analogously be performed on a campus level basis without departing from the scope and spirit of the invention. The financial support for school campus management 255 is called out as a specific example, but those having skill in the art will recognize that campus level assessment and management is clearly extendible from any functionality performed at a district level as well.

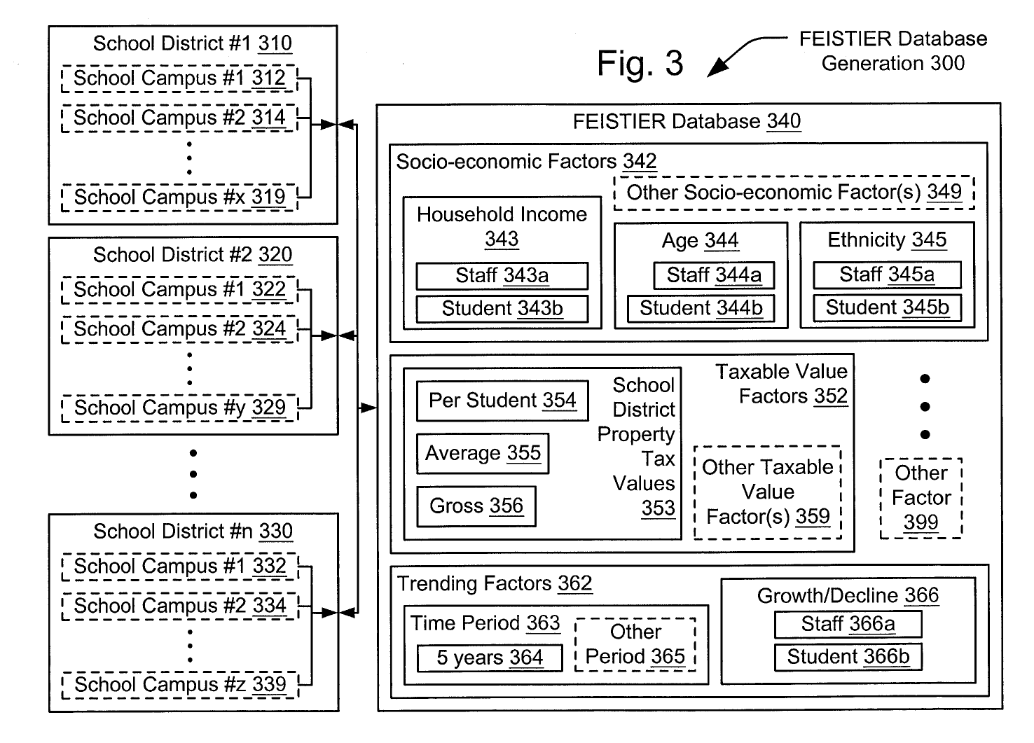

FIG. 3 is a functional diagram illustrating an embodiment of FEISTIER database generation 300 that is performed using certain aspects of the invention. The FEISTIER database generation 300 generates a FEISTIER database 340, taking information from a number of school districts shown as a school district #1 310, a school district #2 320, . . . , and a school district #n 330. The FEISTIER database generation may employs processing circuitry to perform integration and processing of the various functions described herein. The processing circuitry may include a computer or other hardware capable of performing processing in various embodiments of the invention. If desired, information is further included from among school campuses within each of the school districts to be incorporated to generate the FEISTIER database 340. For example, the school district #1 310 may include a number of school campuses, shown as a school campus #1 312, a school campus #2 314, . . . , and a school campus #x 319. Similarly, the school district #2 320 may include a number of school campuses, shown as a school campus #1 322, a school campus #2 324, . . . , and a school campus #y 329; . . . ; school district #n 330 may include a number of school campuses, shown as a school campus #1 332, a school campus #2 334, . . . , and a school campus #z 339.

In general, the FEISTIER database 340 includes information based on socio-economic factors 342, taxable value factors 352, trending factors 362, and any other number of factors shown as . . . an other factor 399. As more areas may identified that are suitable for inclusion within the FEISTIER database 340, more factors may be included by drawing upon information provided by the school districts and school campuses within the school system.

The socio-economic factors 342 includes information of household income 343, age 344, and ethnicity 345 as well as any number of other socio-economic factor(s) 349 that may be included. The various factors within the socio-economic factors 342 may be broken down further on a staff basis or a student basis. The FEISTIER system, in all of its various embodiments, is able to incorporate the effects of not only the student-based socio-economic factors, but also staff-based socio-economic factors within the socio-economic factors 342. For example, the household income 343 may be provided with such granularity as to show househol income 343 on a staff basis 343a (either total or per staff member, depending on the granularity of information desired). Similarly, the household income 343 may be broken down on a student basis 343b (either total or per student, depending on the granularity of information desired). The age 344 may also be further broken down as shown by staff 344a and student 344b. Again, the ethnicity may also be further broken down as shown by staff 345a and student 345b. There are other ways of breaking down these factors without departing from the scope and spirit of the invention as well.

The taxable value factors 352 include school district property tax values 353 and may include any other taxable value factor(s) 359 that may be desired for a given application. The school district property tax values 353 are broken down on a per student level 354, an average level 355, and a gross level 356. The trending factors 362 include a time period 363 and growth/decline information 366 over the time period 363. The time period is 5 years, as shown by a block 364; the time period 363 may alternatively be any other time period 365 as desired in a given application. The growth/decline information 366 may be provided on a staff basis or a student basis, as shown by the blocks 366a and 366b.

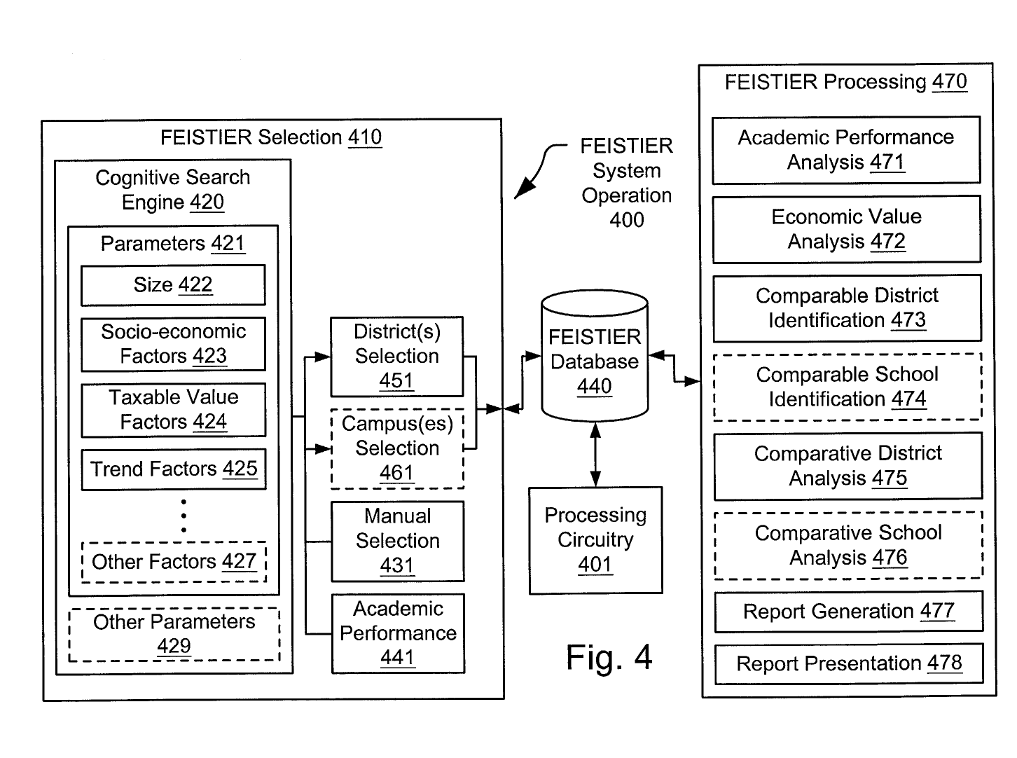

FIG. 4 is a functional diagram illustrating an embodiment of FEISTIER system operation 400 performed in accordance with certain aspects of the invention. The FEISTIER system operation 400 allows for FEISTIER selection 410 of district(s) or campus(es) (shown within the blocks 451 and 461) from a FEISTIER database 440. In addition, FEISTIER processing 470 may also be performed using the FEISTIER database 440. The FEISTIER system operation 400 may be performed by employing processing circuitry 401 to perform integration and processing of the various functions described herein. The processing circuitry 401 may include a computer or other hardware capable of performing processing in various embodiments of the invention.

The FEISTIER selection 410 is operable to perform selection based upon manual selection 431 or academic performance 441. However, when analysis of the various entities within the school system is unknown to a user, the user may perform FEISTIER selection 410 using a cognitive search engine 420. The cognitive search engine 420 employs a number of parameters 421 that are described using a number of factors. Some of the factors used to describe the number of parameters 421 include size 422, socio-economic factors 423, taxable value factors 424, and trend factors 425. In addition, any other factors 427 may also be used to describe the various parameters 421. These factors may be at a district, campus, or other entity level within the school system. In addition, other parameters 429 may be employed as desired within certain applications.

The selection within the FEISTIER selection 410 selects one or more school districts or school campuses from the FEISTIER database 440, again as shown within the blocks 451 and 461. If desired, the selection of the one or more school districts or school campuses from the FEISTIER database 440 may also be used subsequently to perform the FEISTIER processing 470. The FEISTIER processing 470 includes academic performance analysis 471, economic value analysis 472, report generation 477, and report presentation 478 (to a user). Within each of these various functions contained within the FEISTIER processing 470, it is often desirable to identify comparable districts (and campuses) as shown in a block 473 (and a block 474). Similarly, after identification is performed, then analysis on comparable districts (and campuses) may also be performed as shown in a block 475 (and a block 476).

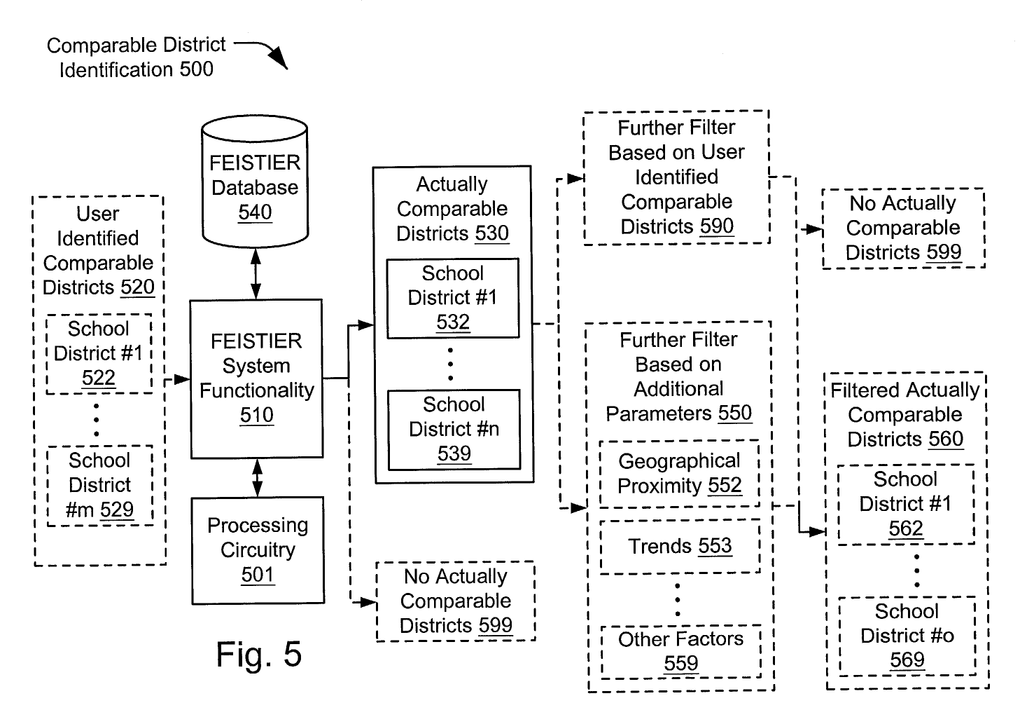

FIG. 5 is a functional diagram illustrating an embodiment of comparable district identification 500 that is performed using certain aspects of the invention. The comparable district identification 500 may be performed by employing processing circuitry 501 to perform integration and processing of the various functions described herein. The processing circuitry 501 may include a computer or other hardware capable of performing processing in various embodiments of the invention.

FEISTIER system functionality 510 interacts with a FEISTIER database 540 to identify actually comparable districts 530, as shown by a school district #1 532, . . . , and a school district #n 539. If desired, a user may identify comparable districts within a block 520, as shown by a school district #1 522, . . . , and a school district #m 529. Alternatively, the identification of the actually comparable districts 530 is performed using the FEISTIER system functionality 510 that may include a cognitive search engine as described in various embodiments of the invention. If desired, the FEISTIER system functionality 510 may be used to certify that the user identified comparable districts 520 are actually contained within the actually comparable districts 530. It may be that there are no actually comparable districts 599. Alternatively, the FEISTIER system functionality 510 may be used to certify that the user identified comparable districts 520 does not contain any actually comparable districts 599.

When there are identified actually comparable districts 530, this identification may be further filtered based on user identified comparable districts 590. This further filtering 590 may lead to a result that there are no actually comparable districts 599. Alternatively, there may be filtered actually comparable districts 560, shown as a school district #1 562, . . . , and a school district #o 569. Similarly, when there are identified actually comparable districts 530, this identification may be further filtered based on additional parameters 550. These additional parameters that may assist in filtering within the block 550 may include geographical proximity 552, trends 553, . . . , and other factors 559. These additional parameters may ensure that the actually comparable districts 530 are truly comparable. Again and similar to the filtering shown above, this further filtering 550 may lead to a result that there are no actually comparable districts 599. Alternatively, there may be filtered actually comparable districts 560, shown as a school district #1 562, . . . , and a school district #o 569. This filtered actually comparable districts 560 may be different for each of the filtering 590 and 550 in various embodiments of the invention. The various stages of filtering shown in the FIG. 5 may be viewed as contained within the entire comparable district identification 500. The various stages of filtering may be unseen by a user of the FEISTIER system, or the user may have access to govern the filtering at various stages during its processing.

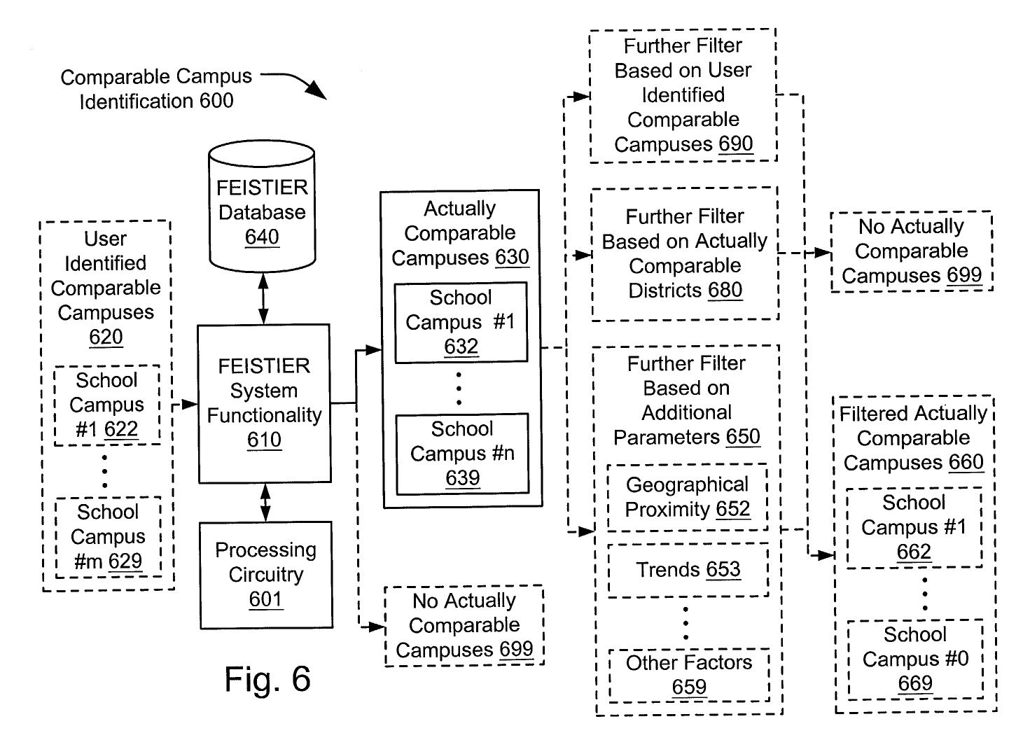

FIG. 6 is a functional diagram illustrating an embodiment of comparable campus identification 600 that is performed using certain aspects of the invention. The comparable campus identification 600 may be performed by employing processing circuitry 601 to perform integration and processing of the various functions described herein. The processing circuitry 601 may include a computer or other hardware capable of performing processing in various embodiments of the invention.

FEISTIER system functionality 610 interacts with a FEISTIER database 640 to identify actually comparable campuses 630, as shown by a school campus #1 632, . . . , and a school campus #n 639. If desired, a user may identify comparable campuses within a block 620, as shown by a school campus #1 622, . . . , and a school campus #1 629. Alternatively, the identification of the actually comparable campuses 630 is performed using the FEISTIER system functionality 610 that may include a cognitive search engine as described in various embodiments of the invention. If desired, the FEISTIER system functionality 610 may be used to certify that the user identified comparable campuses 620 are actually contained within the actually comparable campuses 630. It may be that there are no actually comparable campuses 699. Alternatively, the FEISTIER system functionality 610 may be used to certify that the user identified comparable campuses 620 does not contain any actually comparable campuses 699.

When there are identified actually comparable campuses 630, this identification may be further filtered based on user identified comparable campuses 690. This further filtering 690 may lead to a result that there are no actually comparable campuses 699. Alternatively, there may be filtered actually comparable campuses 660, shown as a school campus #1 662, . . . , and a school campus #o 669. Similarly, when there are identified actually comparable campuses 630, this identification may be further filtered based on actually comparable districts 680. Again and similar to the filtering shown above, this further filtering 680 may lead to a result that there are no actually comparable campuses 699. Alternatively, there may be filtered actually comparable campuses 660, shown as a school campus #1 662, . . . , and a school campus #o 669. This filtered actually comparable campuses 660 may be different for each of the filtering 690 and 680 in various embodiments of the invention.

Similarly, when there are identified actually comparable campuses 630, this identification may be further filtered based on additional parameters 650. These additional parameters that may assist in filtering within the block 650 may include geographical proximity 652, trends 653, . . . , and other factors 659. These additional parameters may ensure that the actually comparable campuses 630 are truly comparable. Again and similar to the filtering shown above, this further filtering 650 may lead to a result that there are no actually comparable campuses 699. Alternatively, there may be filtered actually comparable campuses 660, shown as a school campus #1 662, . . . , and a school campus #o 669. This filtered actually comparable campuses 660 may be different for each of the filtering 690, 680, and 650 in various embodiments of the invention. The various stages of filtering shown in the FIG. 6 may be viewed as contained within the entire comparable campus identification 600. The various stages of filtering may be unseen by a user of the FEISTIER system, or the user may have access to govern the filtering at various stages during its processing.

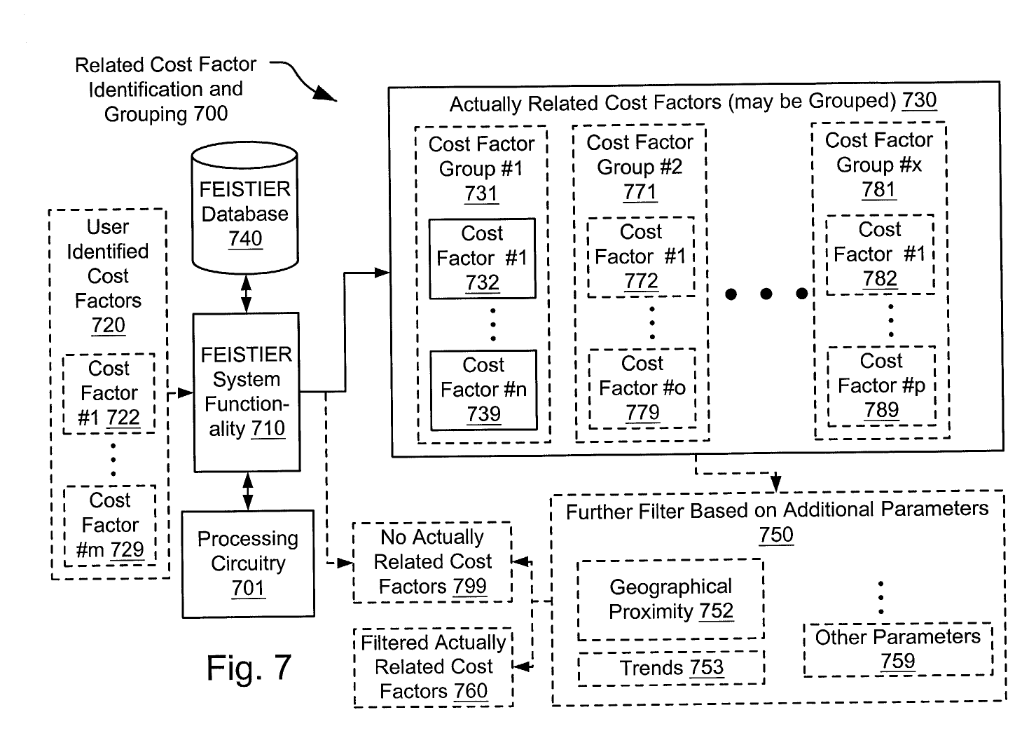

FIG. 7 is a functional diagram illustrating an embodiment of related cost factor identification and grouping 700 that is performed using certain aspects of the invention. The related cost factor identification and grouping 700 may be performed by employing processing circuitry 701 to perform integration and processing of the various functions described herein. The processing circuitry 701 may include a computer or other hardware capable of performing processing in various embodiments of the invention.

FEISTIER system functionality 710 interacts with a FEISTIER database 740 to identify actually related cost factors 730. The actually related cost factors 730 may be grouped in various embodiments of the invention. If desired, a user may identify cost factors, as shown in a block 720. The user identified cost factors 720 may include any number of cost factors as shown by a cost factor #1 722, . . . , and a cost factor #m 729. The actually related cost factors 730 include a cost factor #1 732, . . . , and a cost factor #n 739. If desired, the actually related cost factors 730 may include a number of cost factors groups, as shown by a cost factor group #1 731, a cost factor group #2 771, . . . , and a cost factor group #x 781. For example, the cost factor group #1 731 may include the cost factor #1 732, . . . , and the cost factor #n 739. The cost factor group #2 771 may include a cost factor #1 771, . . . , and a cost factor #o 779. It may be that there are no actually related cost factors 799.

When there are identified actually related cost factors 730, this identification may be further filtered based on additional parameters 750. This further filtering 750 may lead to a result that there are no actually related cost factors 799. Alternatively, there may be filtered actually related cost factors 760. These additional parameters that may assist in filtering within the block 750 may include geographical proximity 752, trends 753, . . . , and other factors 759. These additional parameters may ensure that the actually related cost factors 730 are truly comparable. Again and similar to the filtering shown above, this further filtering 750 may lead to a result that there are no actually related cost factors 799.

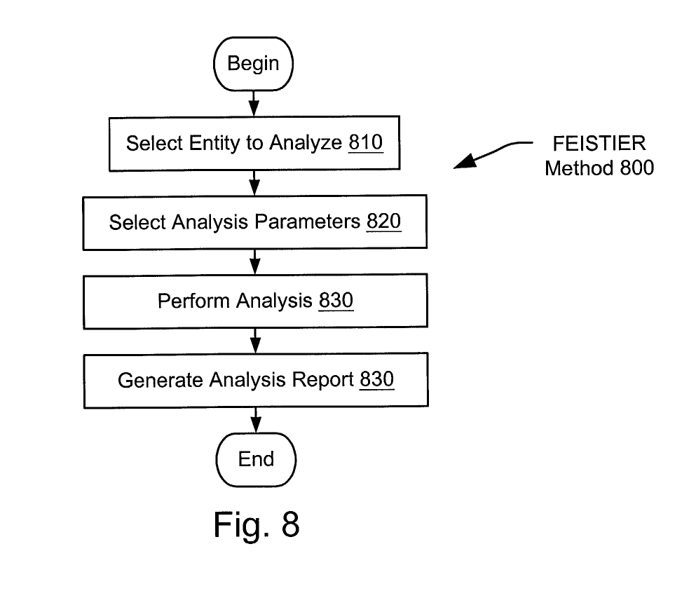

FIG. 8 is a functional block diagram illustrating an embodiment of a FEISTIER method 800 that is performed in accordance with certain aspects of the invention. In a block 810, an entity is selected to be analyzed. The entity in the block 810 may be a school district, a school campus, or any other entity within the various levels of organization within the school system. Then, in a block 820, analysis parameters are selected to control the analysis of the entity selected within the block 810. Then, based on the analysis parameters selected in the block 820, analysis is performed in a block 830 using any of the various embodiments of FEISTIER systems and FEISTIER processing described in the various embodiments of the invention. Then, after that analysis is performed in the block 830, then an analysis report is generated in a block 840 based on the analysis of the block 830.

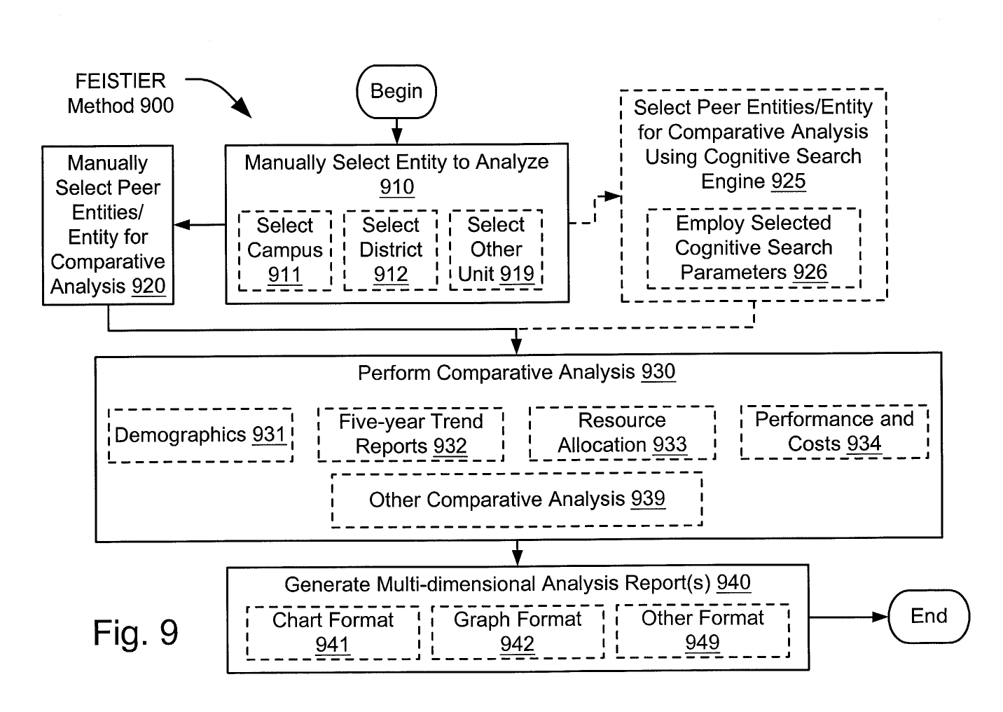

FIG. 9 is a functional block diagram illustrating another embodiment of a FEISTIER method 900 that is performed in accordance with certain aspects of the invention. In a block 910, an entity is manually selected to be analyzed. The selection may include a selection of a campus 911, a selection of a district 912, and a selection of any other unit 919. Then, one or more peer entities are manually selected for comparative analysis in a block 920. Alternatively, one or more peer entities are selected for comparative analysis using a cognitive search engine as shown in a block 925. In addition, a selected group of cognitive search parameters 926 may be employed to perform the cognitive search engine selection in the block 925.

Then, in a block 930, comparative analysis is performed using the selected entity with the one or more peer entities, whether the one or more peer entities are manually selected or selected using cognitive search engine selection. The comparative analysis 930 includes any number of analyses including analysis of demographics 931, five-year trend reports 932, resource allocation 933, performance and costs 934. In addition, other comparative analysis 939 may be performed within the comparative analysis 930 without departing from the scope and spirit of the invention.

Finally, in a block 940, an analysis report is generated. As mentioned above in various embodiments of the invention, an analysis or output report may include a single report, a number of reports, or one or more multi-dimensional reports. The analysis report 940 may be in any number of formats including a chart format 941, a graph format 942, or some other format 949 without departing from the scope and spirit of the invention.

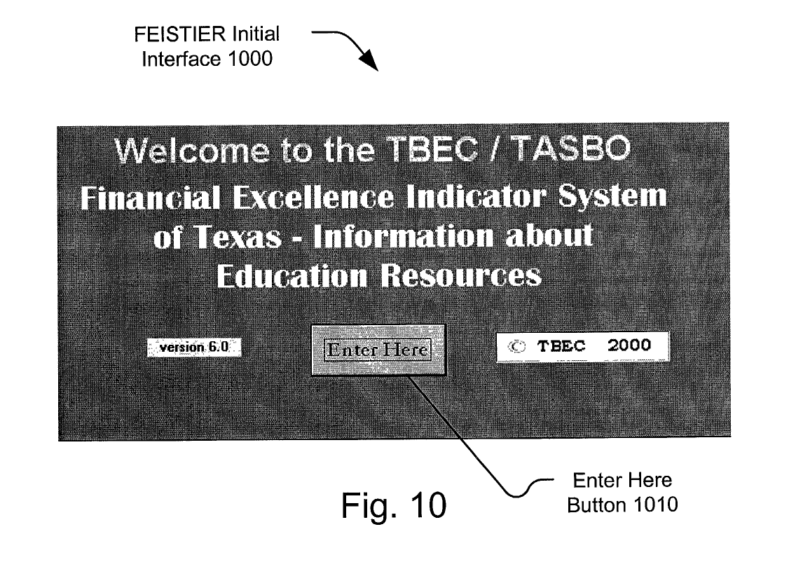

FIG. 10 is a descriptive diagram illustrating an embodiment of a FEISTIER initial interface 1000 that is constructed in accordance with certain aspects of the invention. The FEISTIER initial interface 1000 may be viewed, from certain perspectives, as the initial interface that is ever seen by a user using a graphical user interface (GUI) to access the various FEISTIER functionality offered in various embodiments of the invention. The FEISTIER system, and all of its associated functionality, may be supported on a computer. The computer may employ a GUI that shows the FEISTIER initial interface 1000 to the user. To initiate the use of the FEISTIER system, a user may click on an ENTER HERE button 1010 to enter the FEISTIER system and access additional functionality offered therein.

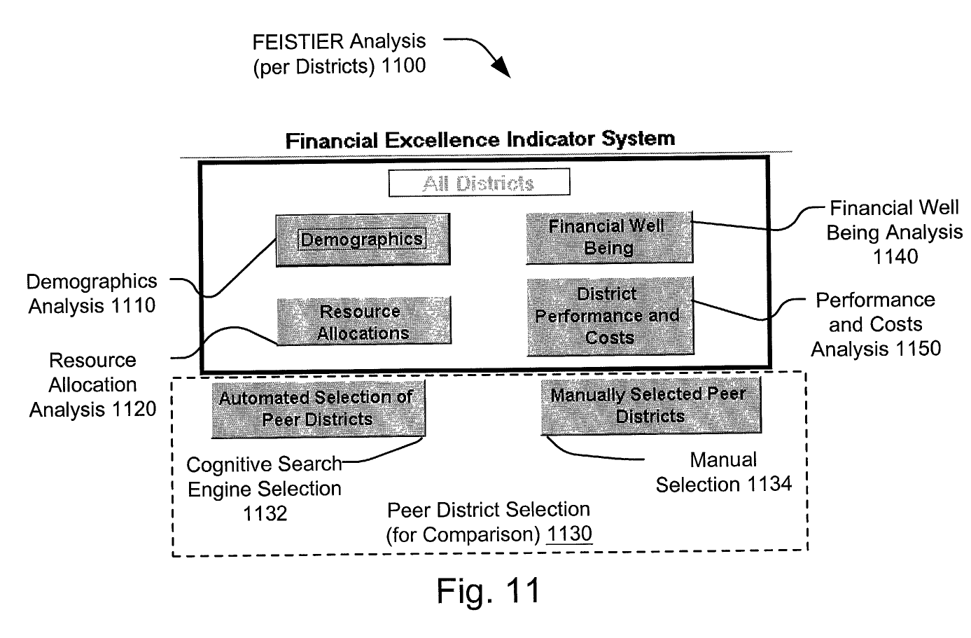

FIG. 11 is a descriptive diagram illustrating an embodiment of a FEISTIER interface 1100 that permits analysis on a per district basis in accordance with certain aspects of the invention. The FEISTIER interface 1100 allows for peer district selection 1130 that may be used for comparison within various embodiments. The peer district selection 1130 may be performed by using a cognitive search engine selection 1132 by clicking an AUTOMATED SELECTION OF PEER DISTRICTS button or by using manual selection 1134 by clicking a MANUALLY SELECTED PEER DISTRICTS button. In addition, when desiring to perform FEISTIER analysis 1100 using the interface shown in the FIG. 11, a user is able to selection a number of various analyses to be performed. For example, a user may perform demographics analysis 1110 by clicking a DEMOGRAPHICS button. In addition, a user may perform resource allocation analysis 1120 by clicking a RESOURCE ALLOCATIONS button. A user may perform financial well being analysis 1140 by clicking a FINANCIAL WELL BEING button. Finally, a user may perform performance and costs analysis 1150 by clicking a DISTRICT PERFORMANCE AND COSTS button.

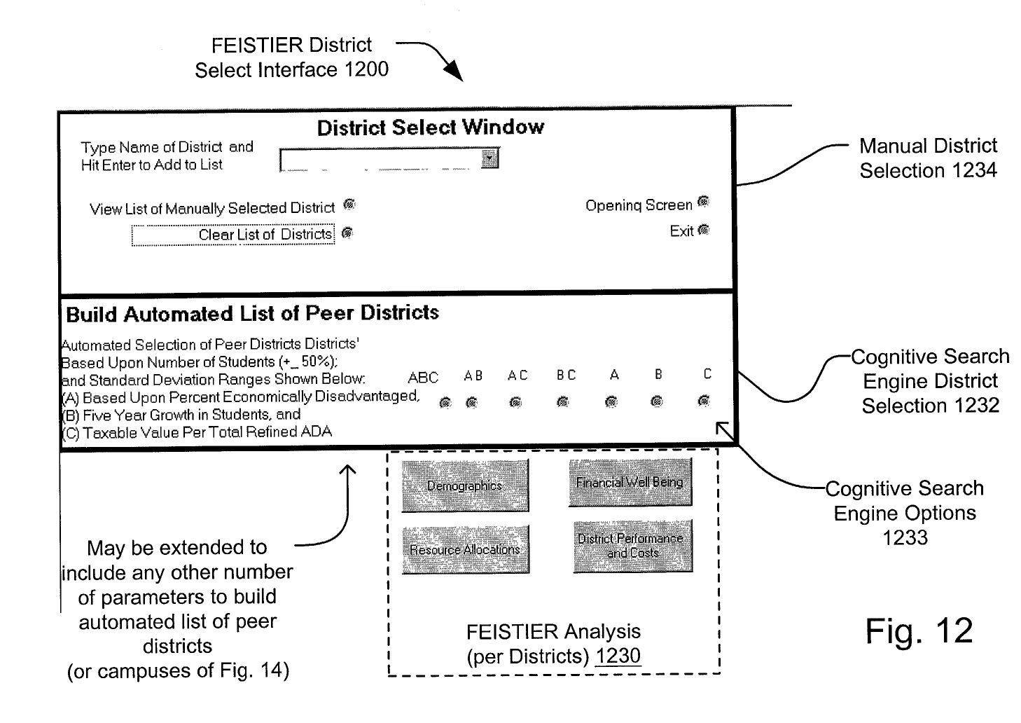

FIG. 12 is a schematic diagram illustrating an embodiment of a FEISTIER interface 1200 that permits district selection in accordance with certain aspects of the invention. A user is able to perform district selection manually as shown by reference numeral 1234. Alternatively, a user is able to employ a cognitive search engine to perform district selection as shown by reference numeral 1232. There are several cognitive search engine options 1233 available to the user when employing the cognitive search engine district selection. For example, a number options are available to the user, and he may select cognitive search engine selection using any one or any combination of those cognitive search engine options 1233 to perform district selection. In the exemplary FEISTIER interface 1200, some of the cognitive search engine options 1233 include based upon percent economically disadvantaged, five year growth in students, and taxable value per total RADA (refined average daily attendance). The analysis is performed using statistical analysis employing standard deviations in generating the analysis employed by the cognitive search engine.

After the selection of the districts is performed within the FEISTIER interface 1200, FEISTIER analysis is performed on a per district basis as shown in a block 1230. The analysis within the block 1230 includes demographics analysis by clicking a DEMOGRAPHICS button, performing resource allocation analysis by clicking a RESOURCE ALLOCATIONS button, performing financial well being analysis by clicking a FINANCIAL WELL BEING button, performing performance and costs analysis by clicking a DISTRICT PERFORMANCE AND COSTS button.

A FEISTIER interface, similar to the FEISTIER interface 1200, may also be employed to perform campus selection or selection of any other entity level within the school system. If desired, such other FEISTIER interfaces also allow for manual entity selection or selection using a cognitive search engine in a manner similar to that shown in the FIG. 12.

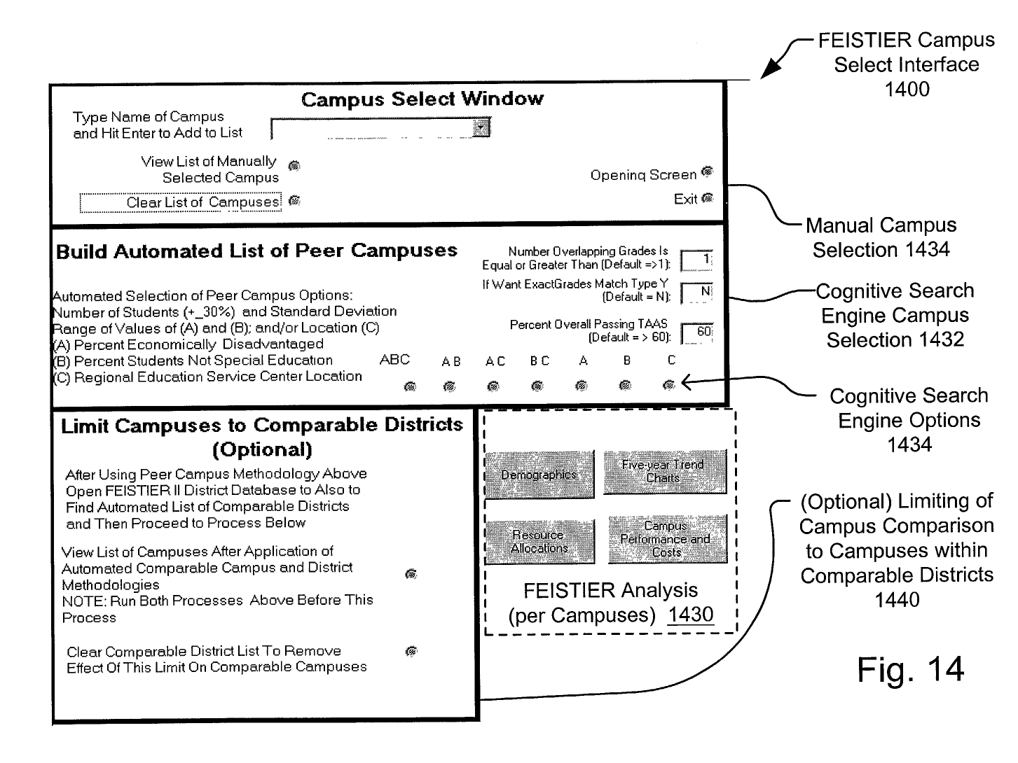

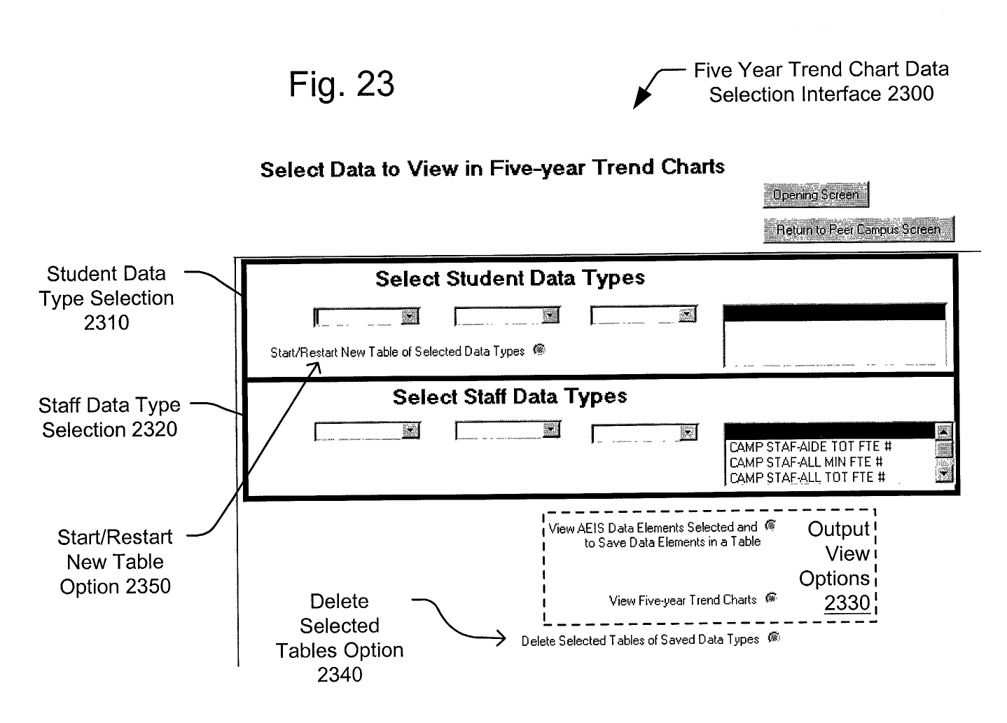

It is further noted that the use of the various criteria to build the automated list of peer districts may be extended to show any other number of parameters. This may also be extended similarly with respect to FIG. 14 in determining comparable campuses as well. Moreover, the number of data types that may be used in performing selection of any of the various elements in the various Figures may also be modified as desired within certain applications. For example, below in the FIG. 23, there may be many more data types to be selected that those shown in the particular embodiment illustrated without departing from the scope and spirit of the invention.

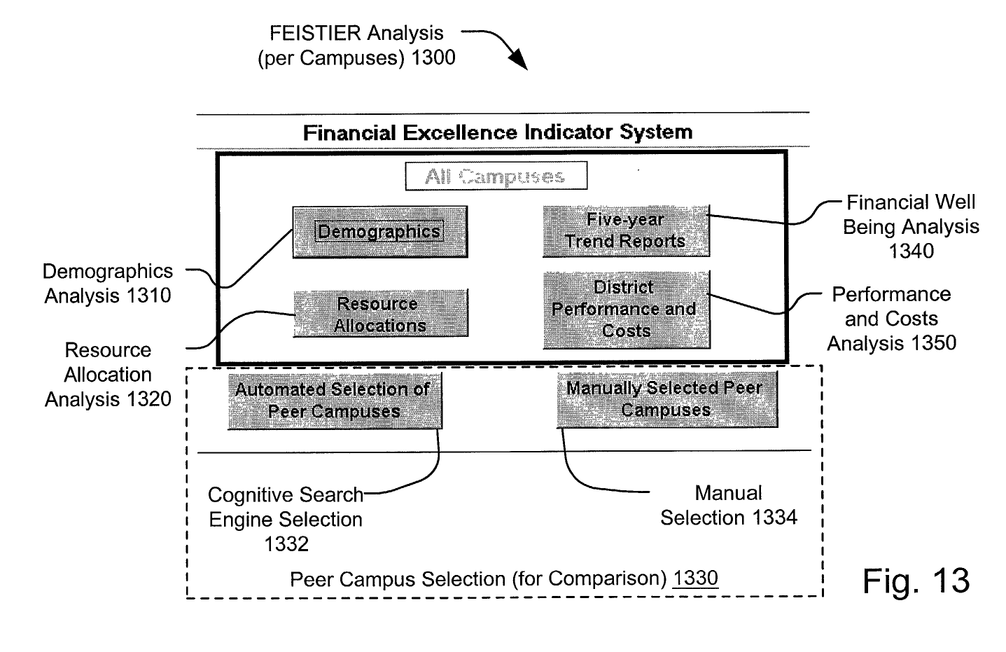

FIG. 13 is a schematic diagram illustrating an embodiment of a FEISTIER interface 1300 that permits analysis on a per campus basis in accordance with certain aspects of the invention. The FEISTIER interface 1300 allows for peer campus selection 1330 that may be used for comparison within various embodiments. The peer campus selection 1330 may be performed by using a cognitive search engine selection 1332 by clicking an AUTOMATED SELECTION OF PEER CAMPUSES button or by using manual selection 1334 by clicking a MANUALLY SELECTED PEER CAMPUSES button. In addition, when desiring to perform FEISTIER analysis 1300 using the interface shown in the FIG. 13, a user is able to selection a number of various analyses to be performed. For example, a user may perform demographics analysis 1310 by clicking a DEMOGRAPHICS button. In addition, a user may perform resource allocation analysis 1320 by clicking a RESOURCE ALLOCATIONS button. A user may perform financial well being analysis 1340 by clicking a FIVE-YEAR TREND REPORTS button. Finally, a user may perform performance and costs analysis 1350 by clicking a CAMPUS PERFORMANCE AND COSTS button.

FIG. 14 is a schematic diagram illustrating an embodiment of a FEISTIER interface 1400 that permits campus selection in accordance with certain aspects of the invention. A user is able to perform campus selection manually as shown by reference numeral 1434. Alternatively, a user is able to employ a cognitive search engine to perform campus selection as shown by reference numeral 1432. There are several cognitive search engine options 1433 available to the user when employing the cognitive search engine campus selection. For example, a number options are available to the user, and he may select cognitive search engine selection using any one or any combination of those cognitive search engine options 1433 to perform campus selection. In the exemplary FEISTIER interface 1400, some of the cognitive search engine options 1433 include based upon percent economically disadvantaged, percent students not special education, and regional education service center location. The analysis is performed using statistical analysis employing standard deviations in generating the analysis employed by the cognitive search engine.

After the selection of the campuses is performed within the FEISTIER interface 1400, FEISTIER analysis is performed on a per campus basis as shown in a block 1430. The analysis within the block 1430 includes demographics analysis by clicking a DEMOGRAPHICS button, performing resource allocation analysis by clicking a RESOURCE ALLOCATIONS button, performing financial well being analysis by clicking a FINANCIAL WELL BEING button, performing performance and costs analysis by clicking a CAMPUS PERFORMANCE AND COSTS button.

In addition, the campus selection may be limited to campus comparison to campuses within comparable districts, as shown by the reference numeral 1440, as also described above in various embodiments of the invention. This further limiting 1440 is optional in various embodiments of the invention.

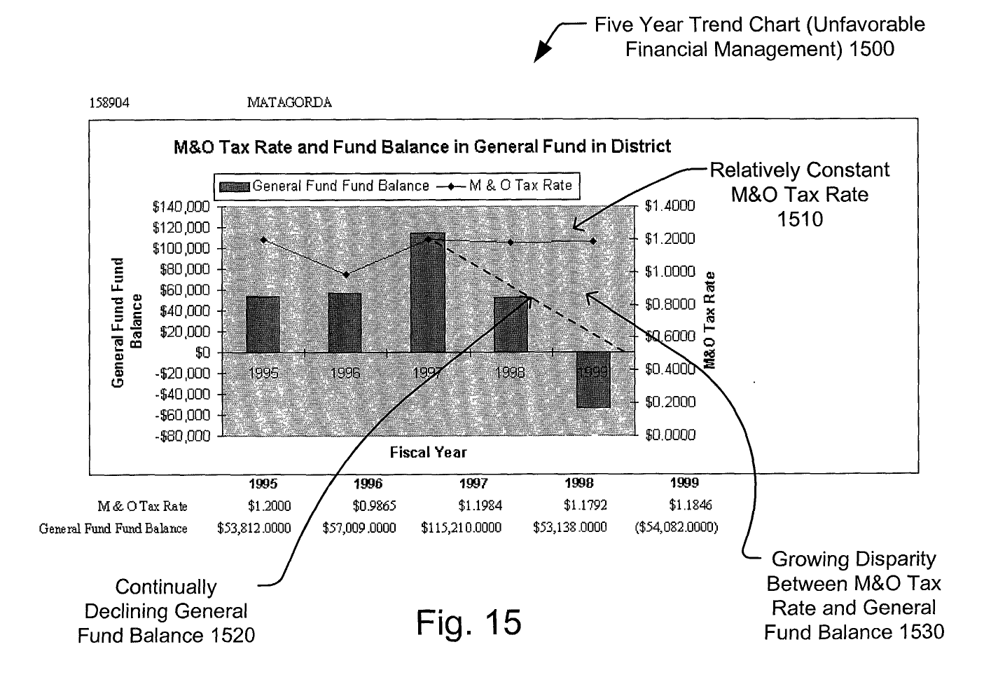

FIG. 15 is a diagram illustrating a five-year trend chart 1500, output by the FEISTIER system, that provides information indicative of unfavorable financial management. Particularly, the five-year trend chart 1500 shows data from five years and shows a relatively constant M&O (maintenance and operations) tax rate 1510 over the later years within the five-year trend chart 1500. The M&O tax rate 1510 includes items such as salaries, utilities, and day to day operations to provide revenues needed to cover maintenance and operations within the district.

However, the five-year trend chart 1500 also shows a continually declining general fund balance 1520. As time progresses, there is a growing disparity between M&O tax rate and general fund balance as shown by the reference numeral 1530. This lack of matching between the M&O tax rate 1510 and the continually declining general fund balance 1520 are in a trend to lead to potential financial resource problems in the future. The FEISTIER system allows a user to view such trends to determine and analyze problems before they become entirely catastrophic. By viewing the trends of such items as shown in the five-year trend chart 1500, a user may intelligently make decisions to curb the potentially disastrous trends within the district and try to match up the M&O tax rate and the general fund balance within a reasonable period of time.

The five-year trend chart 1500 is exemplary of one of the many types of reports that may be generated by the FEISTIER system to assist in the assessment and management of resource allocation within a school district. Clearly, this type of analysis may be extended to campuses and other entity-levels within the school system.

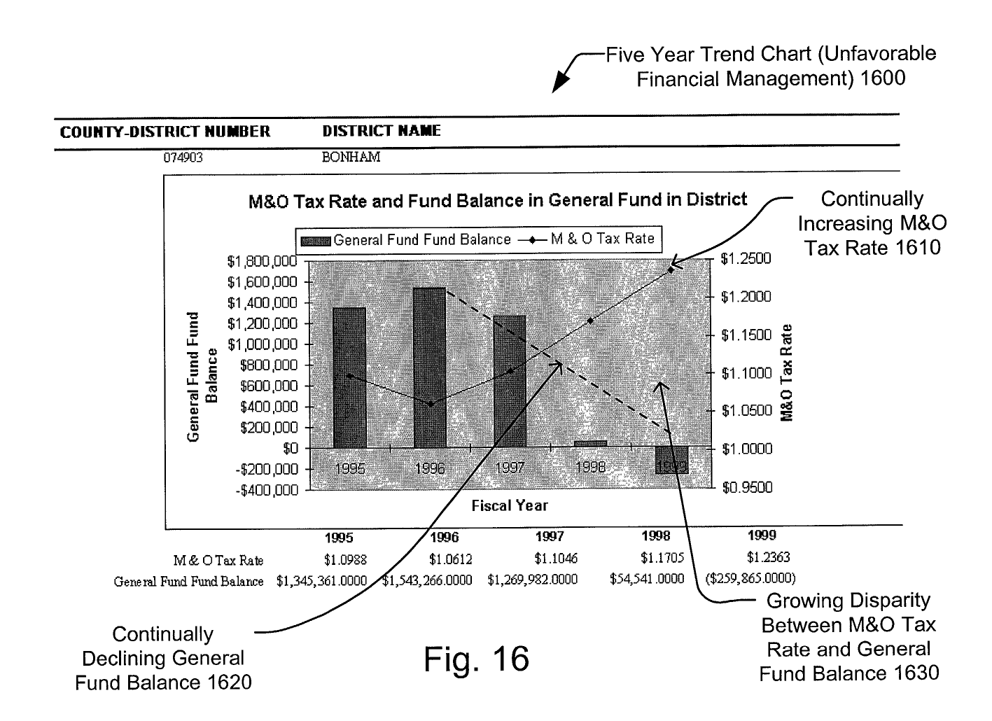

FIG. 16 is a diagram illustrating another five-year trend chart 1600, output by the FEISTIER system, that provides information indicative of unfavorable financial management. Particularly, the five-year trend chart 1600 shows data from five years and shows a continually increasing M&O tax rate 1610 over nearly all of the years within the five-year trend chart 1600. However, the five-year trend chart 1600 also shows a continually declining general fund balance 1620. As time progresses, there is a radically growing disparity between M&O tax rate and general fund balance as shown by the reference numeral 1630. This lack of matching between the M&O tax rate 1610 and the continually declining general fund balance 1620 are in a trend to lead to potential financial resource problems in the future. This example, shown by the five-year trend chart 1600, shows an even more drastic situation than that shown in the FIG. 15. The M&O tax rate and the general fund balance are trending in entirely opposite directions.

The FEISTIER system allows a user to view such trends to determine and analyze problems before they become entirely catastrophic. In this example, if a user were only given a snap-shot analysis, say near the middle of the five-year trend chart 1600 where the M&O tax rate and the general fund balance appear to cross-over one another, the user may wrongly surmise that no problem exists on the horizon. However, given the trend analysis offered by the FEISTIER system, a user can see that although the values of the M&O tax rate and the general fund balance may be somewhat close at any given time in terms of real values, the trends they may be following may tend to indicate an entirely different story. The ability of the FEISTIER system to integrate and assemble such information into a report for use in assessment and management of the district.

Again, the five-year trend chart 1600 is simply exemplary of one of the many types of reports that may be generated by the FEISTIER system to assist in the assessment and management of resource allocation within a school district. Clearly, this type of analysis may also be extended to campuses and other entity-levels within the school system.

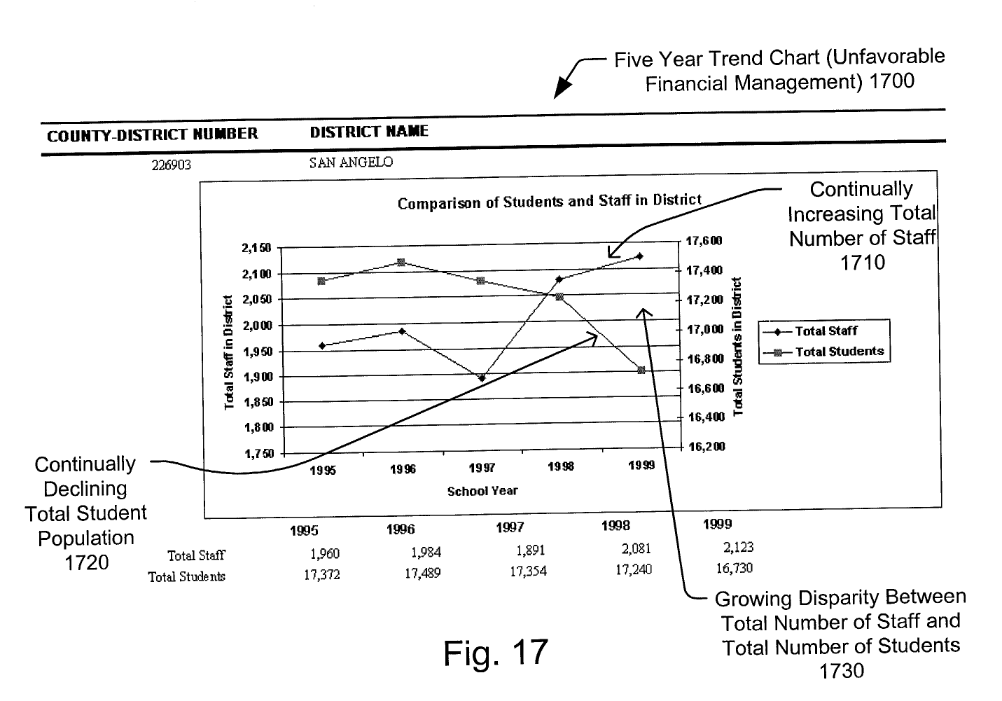

FIG. 17 is a diagram illustrating another five-year trend chart 1700, output by the FEISTIER system, that provides information indicative of unfavorable financial management. Particularly, the five-year trend chart 1700 shows data from five years and shows a continually increasing total number of staff 1710 over the latter years within the five-year trend chart 1700. However, the five-year trend chart 1700 also shows a continually declining total student population 1720 over many of those same years. As time progresses, there is a growing disparity between the total number of staff and the total number of students as shown by the reference numeral 1730. This lack of matching between the total number of staff and the total number of students are in a trend that indicates unfavorable financial management, in that, there appears to be an increasing staff to student ratio.

Now, the analysis provided by the five-year trend chart 1700 may assist a user to recognize this growing staff to student ratio. Then, the FEISTIER system may allow that user to delve further to try to find out why such trends may be occurring. For example, there may be logical and reasonable reasons why such trends are occurring. For example, the percentage of students within the total student population that require special education needs may be increasing, thereby necessitating the increased staff to student ratio. Alternatively, there may be some socio-economic factors that legitimately necessitate such an increased staff to student ratio. The FEISTIER system allows a user not only to see that such trends are occurring, but also to determine why such trends are occurring. Moreover, when there are not such reasons as to why such trends are taking place, the FEISTIER system is also operable to identify those situations as well, and to allow a user to perform intelligent management of the financial resources within the school system as well.

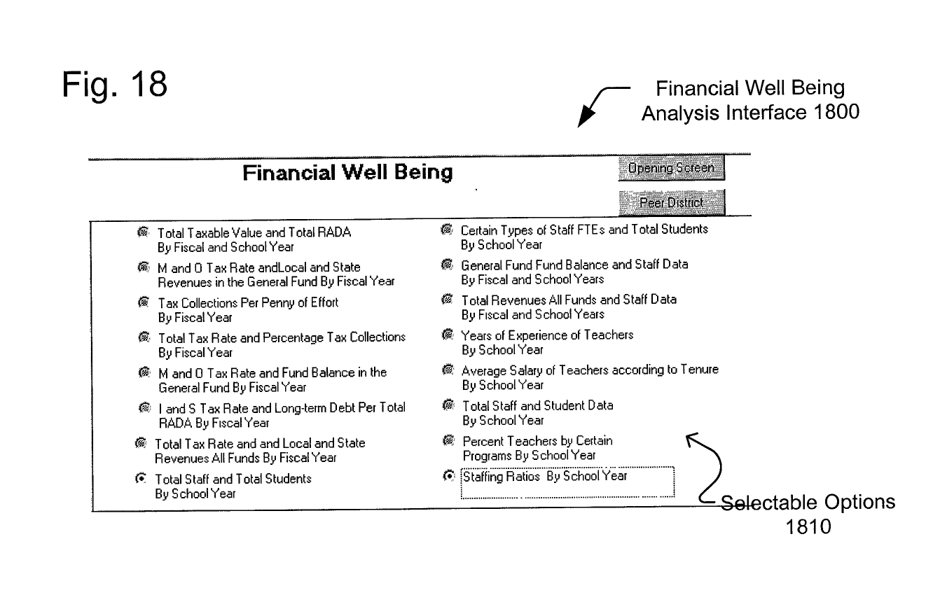

FIG. 18 is a schematic diagram illustrating an embodiment of a FEISTIER interface 1800 that permits financial well being analysis in accordance with certain aspects of the invention. A user is able to perform financial well being analysis using a number of various options. In the embodiment shown in the FIG. 18, a dialogue box shows a number of selectable options 1810 that may be used to perform financial well being analysis.

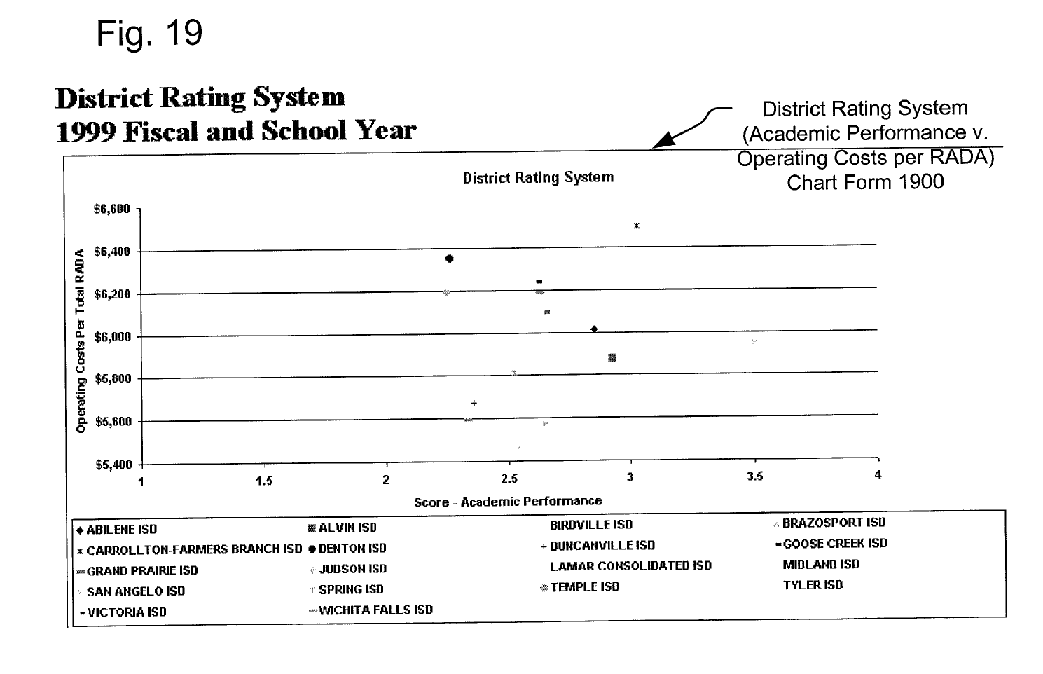

FIG. 19 is a diagram illustrating an embodiment of chart form output 1900 of a district rating system that is provided by the FEISTIER system. The chart form output 1900 shows academic performance rated against operating costs per RADA (refined average daily attendance). The chart form output 1900 of a district rating system shows how any number of school districts may be rated against one another. Similarly, a campus rating system may also be performed in accordance with the invention as well in a manner similar to the rating system operable to rate districts.

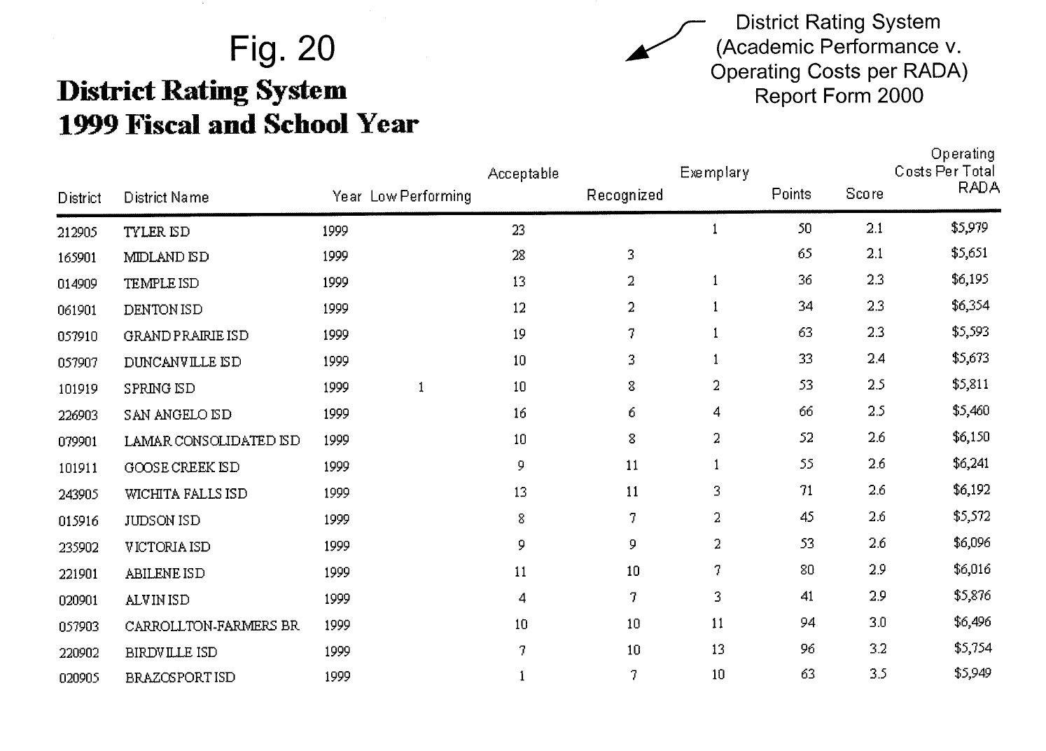

FIG. 20 is a diagram illustrating another embodiment of report form output 2000 of a district rating system that is provided by the FEISTIER system. The district rating system shown within the report form output 2000 shows academic performance rated against operating costs per RADA (refined average daily attendance).

FIG. 21 is a diagram illustrating an embodiment of district performance information output 2100 provided by the FEISTIER system. The district performance information output 2100 involves operating costs (such as M&O) per RADA (refined average daily attendance) for comparable districts that are sorted by amount. The FIG. 21 shows the various ability of the invention, in various embodiments, to perform analysis of comparable districts. The FIG. 21 shows district performance information output 2100 using a particular function, “51 plant maintenance and operations.” Many other functions may also be employed in accordance with the invention. Similarly, the analysis may also be extended to performing analysis of comparable campuses as well without departing from the scope and spirit of the invention.

The FIG. 12 shows the ability of a user to perform subsequent drilling down and even further data mining after being provided indicia of performance of the school district. Once a particular area has been identified, even further granularity within that particular area may be found by the user.

FIG. 22 is a diagram illustrating another embodiment of district performance information output provided by the FEISTIER system. The district performance information output 2200 involves operating costs (such as general administration) per RADA (refined average daily attendance) for comparable districts that are sorted by amount. The FIG. 22 shows the various ability of the invention, in various embodiments, to perform analysis of comparable districts. The FIG. 22 shows district performance information output 2200 using a particular function, “41 general administration.” Many other functions may also be employed in accordance with the invention. Similarly, the analysis may also be extended to performing analysis of comparable campuses as well without departing from the scope and spirit of the invention.

FIG. 23 is a schematic diagram illustrating an embodiment of a FEISTIER interface 2300 that permits five-year trend chart data selection in accordance with certain aspects of the invention. The FEISTIER interface 2300 allows for student data type selection 2310, and staff data type selection 2320. The FEISTIER interface 2300 allows for various output view options 2330. In addition, the FEISTIER interface 2300 allows for a start/restart new table option 2350 and for a delete selected tables option 2340.

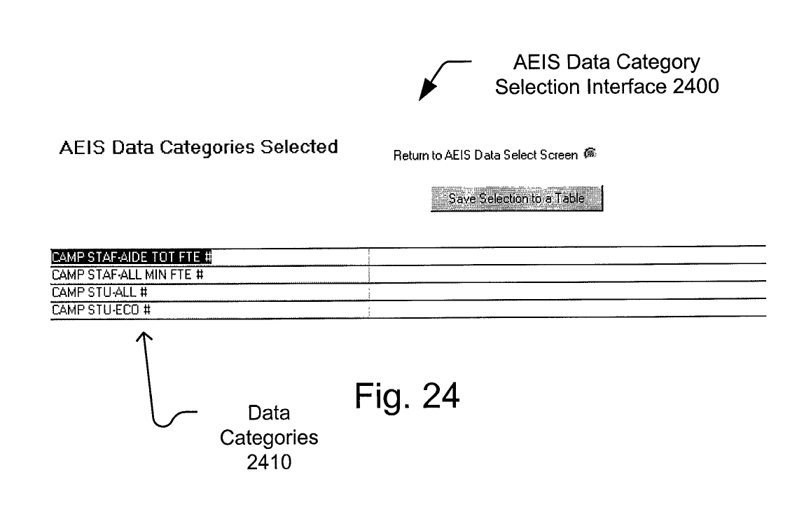

FIG. 24 is a schematic diagram illustrating an embodiment of a FEISTIER interface 2400 that permits data category selection from the Academic Excellence Indicator System (AEIS) in accordance with certain aspects of the invention. The FEISTIER interface 2400 allows for data selection from the Academic Excellence Indicator System (AEIS) and shows one embodiment of data categories 2410.

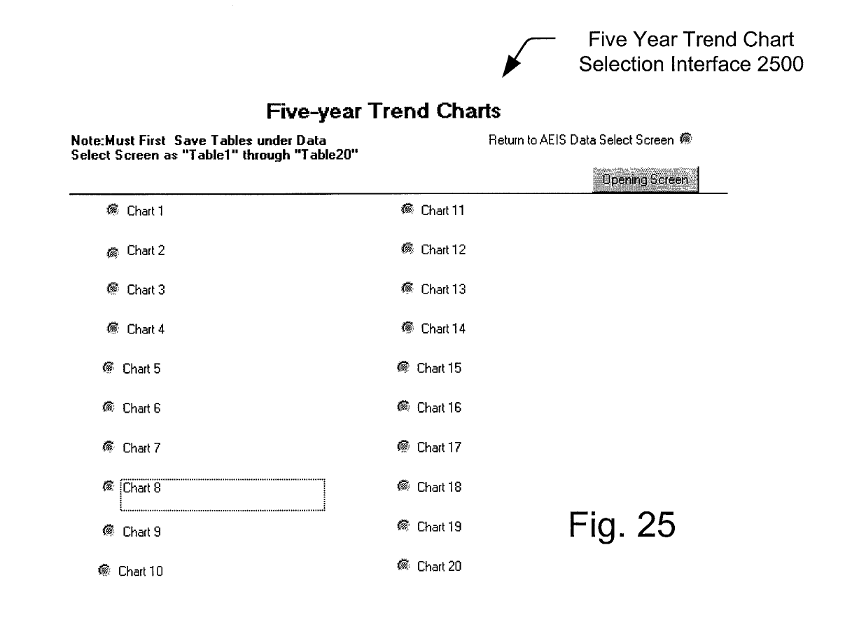

FIG. 25 is a schematic diagram illustrating an embodiment of a FEISTIER interface 2500 that permits five-year trend chart selection in accordance with certain aspects of the invention. The FEISTIER interface 2500 shows how the FEISTIER system is able to generate a number of various charts or tables as output when performing FEISTIER analysis according to various aspects of the invention. Twenty five-year trend charts may be selected for viewed as shown within the FEISTIER interface 2500. In other embodiments, more or fewer than 20 five-year trend charts may be selected as are generated using the FEISTIER analysis.

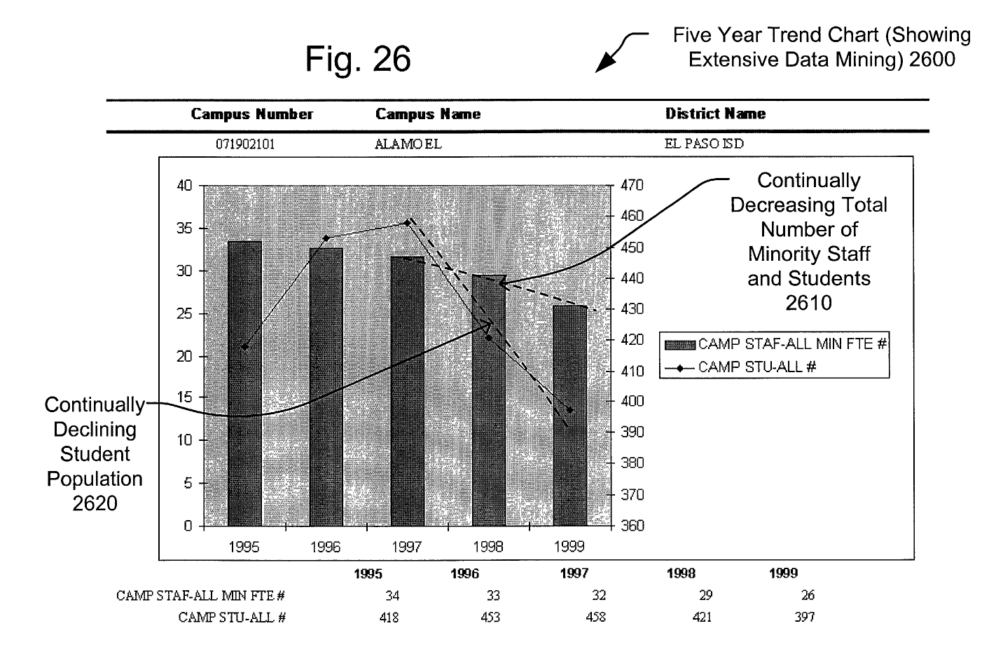

FIG. 26 is a diagram illustrating another five-year trend chart 2600, output by the FEISTIER system, that shows the extensive data mining functionality offered within various aspects of the invention. For example, the five-year trend chart 2600 shows data from five years and shows a continually decreasing total number of minority staff and students 2610 within the five-year trend chart 2600. In addition, the five-year trend chart 2600 also shows a continually declining student population 2620 over the latter of those same years.

The five-year trend chart 2600 shows the extensive data mining within the various databases that are integrated and tied together within the various embodiments of the invention described herein. Using this extensive data mining, a user may assess the many and various factors that significantly affect the school system at the various levels. The example shown in the FIG. 26 includes that of the differing trends of total number of minority staff and students and the student population. While the trends may be heading in a common direction, the rate at which they are changing differs significantly. Such information may be useful in analyzing other aspects that affect the operations and management of the school system.

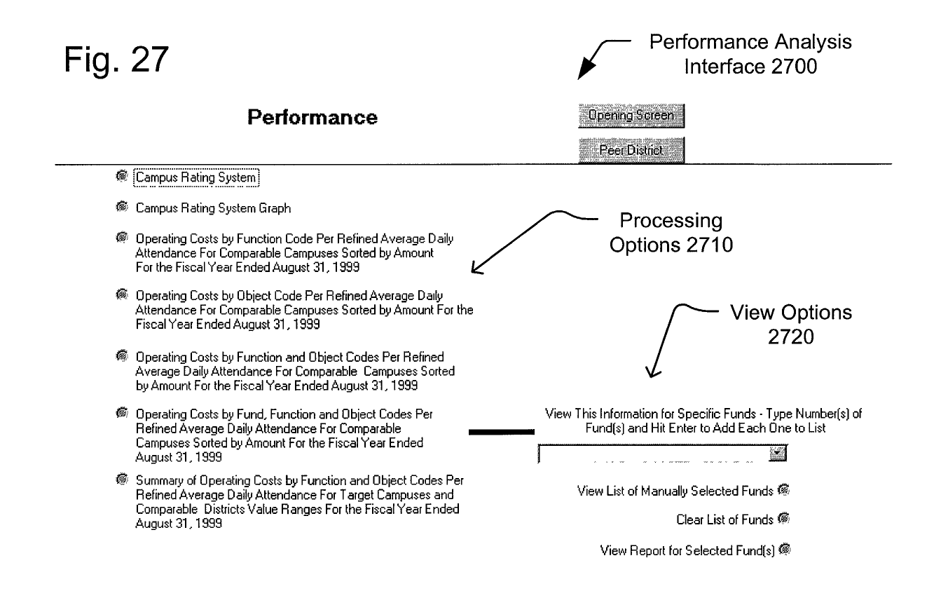

FIG. 27 is a schematic diagram illustrating an embodiment of a performance analysis interface 2700 that is constructed in accordance with certain aspects of the invention. The FEISTIER interface shown by the performance analysis interface 2700 allows a user to select from among a number of different processing options 2710 by which various of the FEISTIER processing functionality and operations may be accessed. In addition, the FEISTIER interface shown by the performance analysis interface 2700 also provides for a number of view options 2720 of how the results from the FEISTIER processing may be viewed once it has been performed. Many of the different processing options 2710 have been shown in other embodiments described herein. For example, one of the processing options 2710 involves employing a CAMPUS RATING SYSTEM. Another of the processing options 2710 involves calculating the OPERATING COSTS BY FUNCTION CODE PER RADA FOR COMPARABLE CAMPUSES. Other examples are shown graphically in the FIG. 27 as well. When desired, other processing options may also be added to the FEISTIER interface without departing from the scope and spirit of the invention as well.

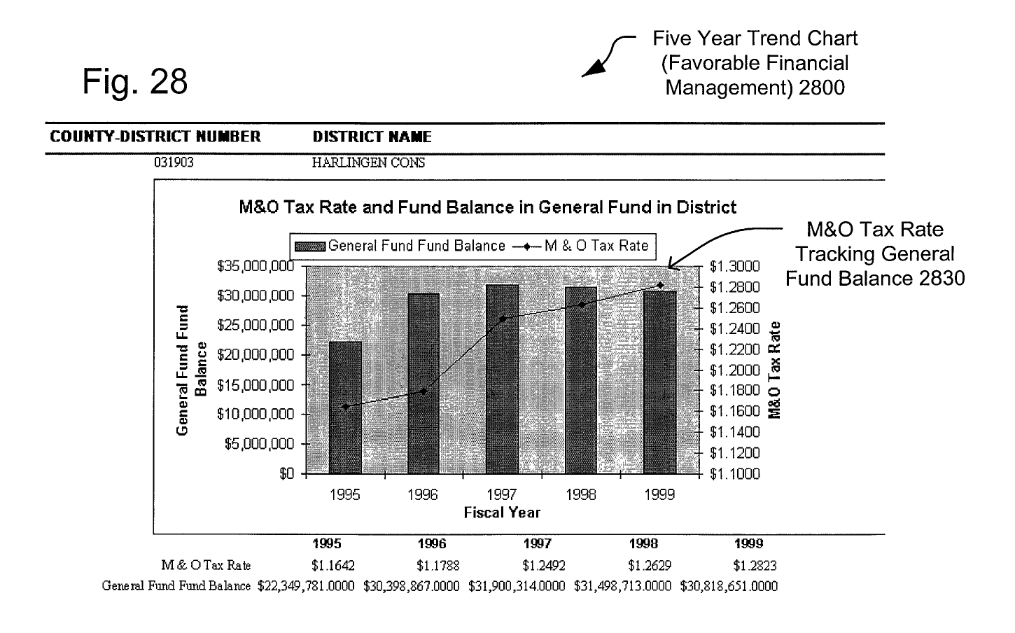

FIG. 28 is a diagram illustrating a five-year trend chart 2800, output by the FEISTIER system, that provides information indicative of favorable financial management. Particularly, the five-year trend chart 2800 shows data from five years and shows a situation where the M&O tax rate and general fund balance are tracking each other substantially well as shown by the reference numeral 2830. The FEISTIER system and its associated functionality allow a user not only to identify problematic areas but also to confirm and verify areas that are being managed very well. The five-year trend chart 2800 is exemplary of such a situation where the financial management seems to be handled in a favorable manner. Such management may be used to identify practices that have led to the successful management and assist users in efforts to seek to emulate such successful practices as much as reasonably possible in other areas.

The five-year trend chart 2800 shows favorable financial management at a district level. Yet again, the FEISTIER system and its associated functionality is also adaptable to perform assessment and management at other division levels within the school system, such as at a campus level, as well. Moreover, the five-year trend chart 2800 shows what seems to have been adaptive management in response to the M&O tax rate and general fund balance being somewhat out of track with one another in the earlier years of the five-year trend chart 2800, yet being corrected so that they begin to track one another very well in the latter years of the five-year trend chart 2800. Another application area in which the FEISTIER system may be used is to commend individuals who have been responsible and have contributed to sound management and adaptation of financial resources within their given spheres of responsibility and influence. The FEISTIER system again allows an objective perspective in assessing management of not only the various entities within the divisions of the school system, but also of the individuals responsible for those divisions.

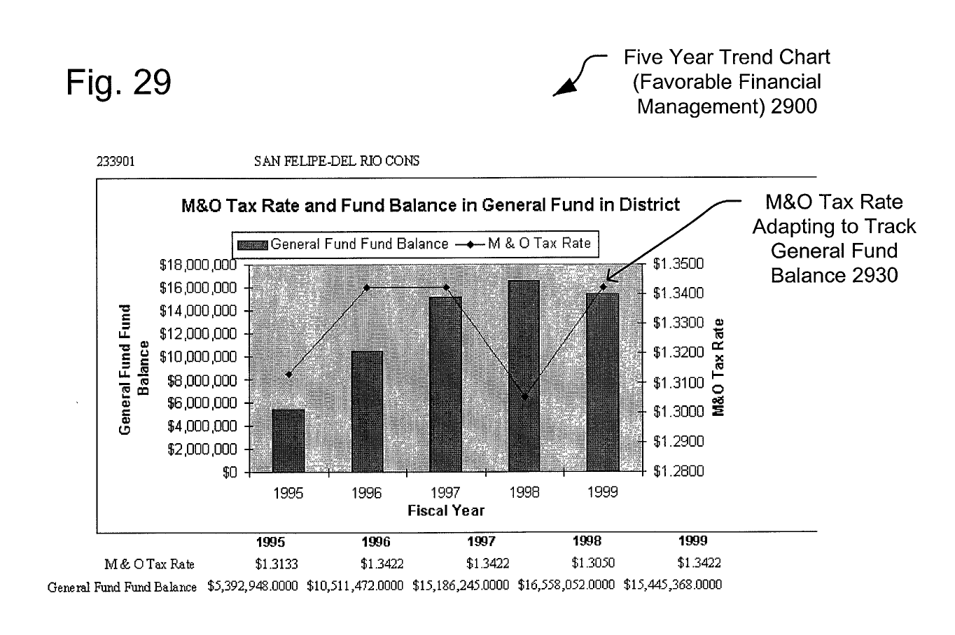

FIG. 29 is a diagram illustrating another five-year trend chart, output by the FEISTIER system, that provides information indicative of favorable financial management. Particularly, the five-year trend chart 2900 shows data from five years and shows a situation where the M&O tax rate and general fund balance are beginning to track each other in the last year of the five-year trend chart 2900 as shown by the reference numeral 2930. In this situation, the FEISTIER system is able to identify a situation where a district had a year where the M&O tax rate and general fund balance began to experience a departure from one another, yet they were adapted to track each other again within the next year. Again, this example of the operation of the FEISTIER system allows a user to view, in a very concise and clear way, how the management of a district is being adapted to meet financial levels of accountability and responsibility.

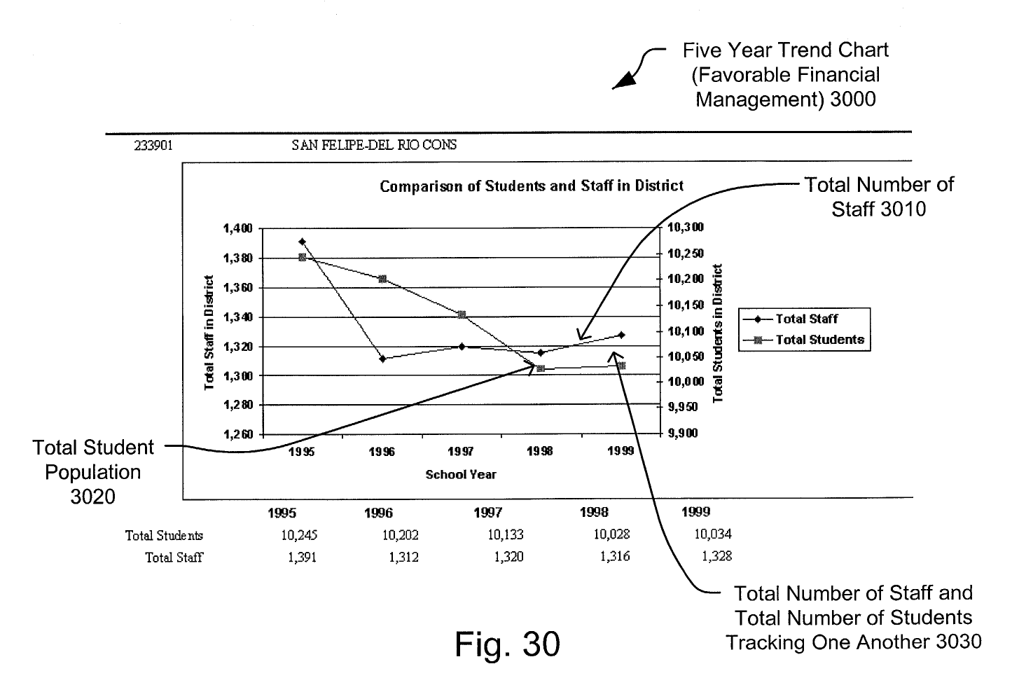

FIG. 30 is a diagram illustrating another five-year trend chart 3000, output by the FEISTIER system, that provides information indicative of favorable financial management. Particularly, the five-year trend chart 3000 shows data from five years and shows a situation where a total student population 3020 and a total number of staff 3010 are being adapted to track one another as shown by the reference numeral 3030. As the total number of students, shown by reference numeral 3020 was beginning to fall off, the total number of staff 3010 was also cut back appropriately. This shows an effort to maintain a relatively constant staff to student ratio.

However, it is also noted that there may be situations where this type of information may be indicative of problems. For example, in a situation where a percentage of the total number of students requiring special education needs was increasing, a maintenance of a relatively constant staff to student ratio would be indicative of something that is problematic. This is yet another of the various functions offered by the FEISTIER system: an ability to view financial management over a predetermined period of time. Yet, a carte blanche analysis is not always made. Consideration may also be give to other factors, one of which has been enumerated here (special education needs). Other factors may also be considered when seeking to make a determination of favorable or unfavorable financial management.

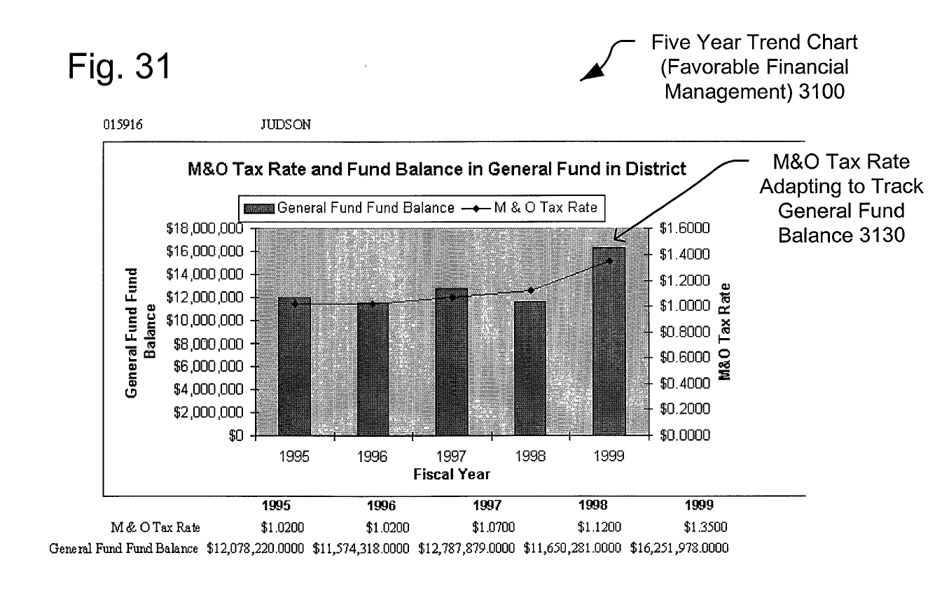

FIG. 31 is a diagram illustrating another five-year trend chart, output by the FEISTIER system, that provides information indicative of favorable financial management. Particularly, the five-year trend chart 3100 shows data from five years and shows a situation where the M&O tax rate and general fund balance are tracking each other substantially well, over nearly all of the five years within the five-year trend chart 3100, as shown by the reference numeral 3130. This example shows a seemingly active effort to ensure that the M&O tax rate and general fund balance comply with one another over nearly all of the years. Such a situation may be exemplary to other districts as to how a district may perform real time, active adaptation to changing M&O tax rates while ensuring that a general fund balance maintains a comparable value.

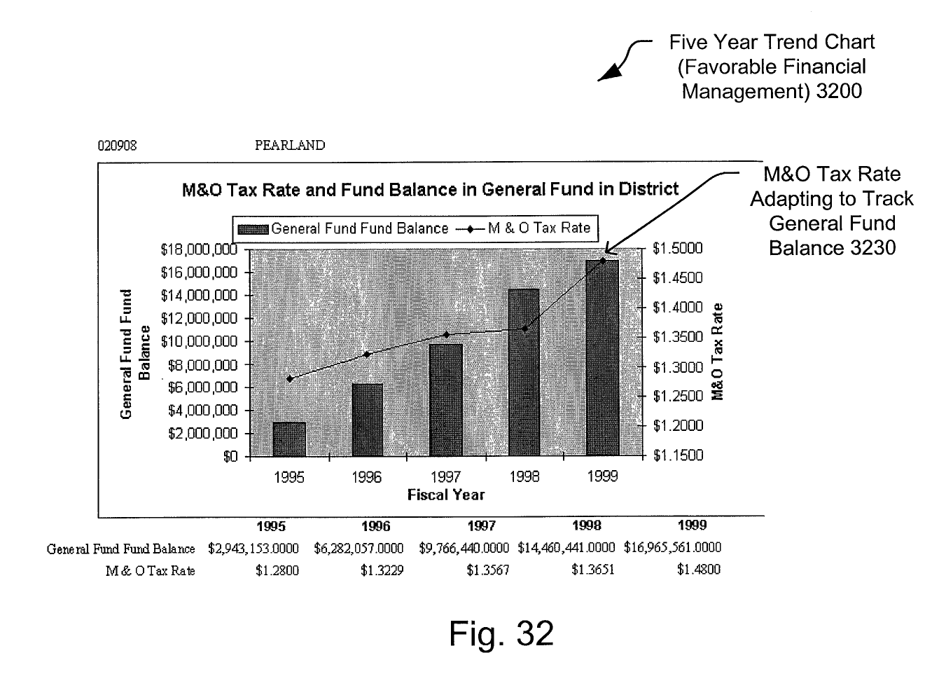

FIG. 32 is a diagram illustrating another five-year trend chart 3200, output by the FEISTIER system, that provides information indicative of favorable financial management. Particularly, the five-year trend chart 3200 also shows data from five years and shows a situation where the M&O tax rate and general fund balance are tracking each other substantially well within the five-year trend chart 3200, as shown by the reference numeral 3230.

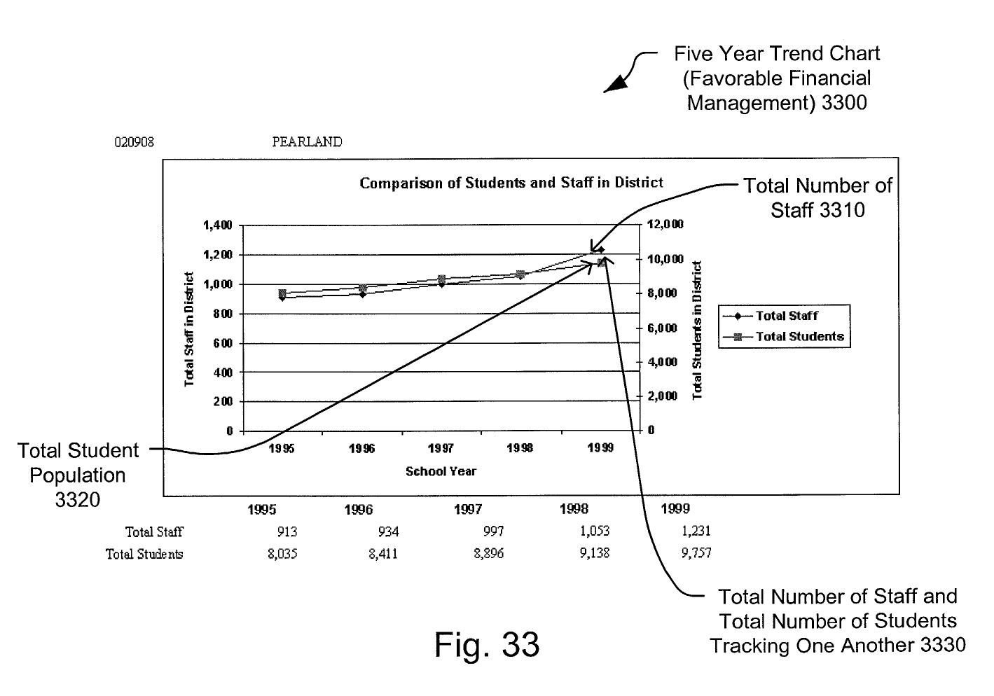

FIG. 33 is a diagram illustrating another five-year trend chart, output by the FEISTIER system, that provides information indicative of favorable financial management. Particularly, the five-year trend chart 3300 shows data from five years and shows a situation where a total student population 3320 and a total number of staff 3310 are being adapted to track one another as shown by the reference numeral 3330. As the total number of students, shown by reference numeral 3320 was beginning to increase slightly, the total number of staff 3310 was also slightly increased appropriately. This shows an effort to maintain a relatively constant staff to student ratio.

However, it is again noted that there may be situations where this type of information may be indicative of problems, as described above regarding the FIG. 30. Again as an example, in a situation where a percentage of the total number of students requiring special education needs was increasing, a maintenance of solely a relatively constant staff to student ratio, without increasing staff to accommodate those special education needs, would be indicative of something that is problematic.

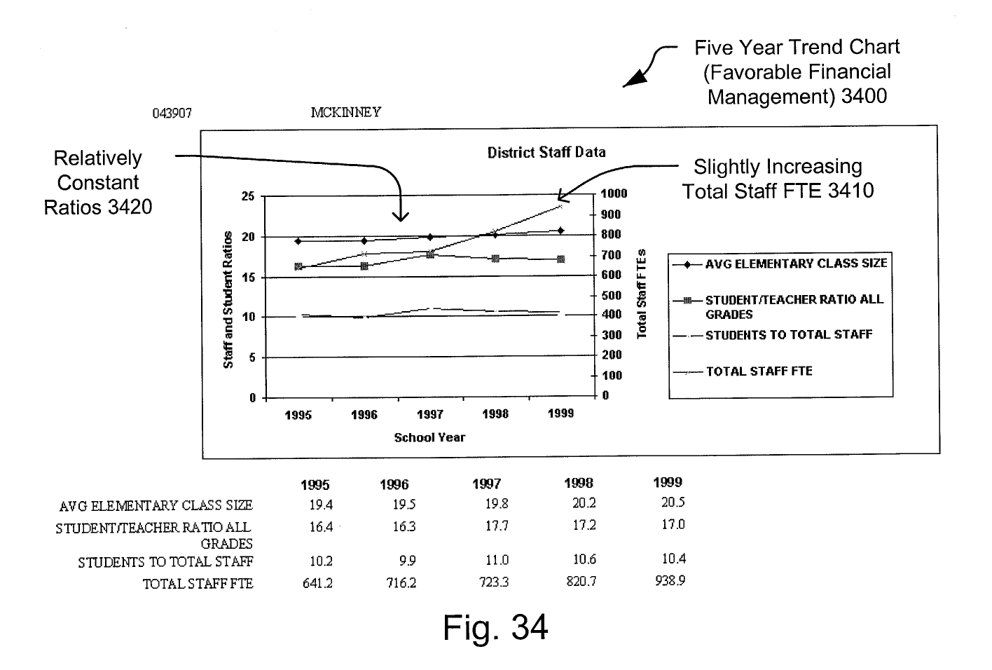

FIG. 34 is a diagram illustrating another five-year trend chart 3400, output by the FEISTIER system, that provides information indicative of favorable financial management. Particularly, the five-year trend chart 3400 shows data from five years and shows a situation where a number of items all seem to track one another leading to relatively constant ratios when comparing them. For example, only one of the items, a total staff FTE (full time equivalent employee) seems to be slightly increasing as shown by the reference numeral 3410. The other items in this example, AVERAGE ELEMENTARY CLASS SIZE, STUDENTS/TEACHER RATIO ALL GRADES, and STUDENT TO TOTAL STAFF items all appear to be relatively constant. This information is indicative of favorable financial management over the several years within the five-year trend chart 3400.

In view of the above detailed description of the present invention and associated drawings, other modifications and variations will now become apparent to those skilled in the art. It should also be apparent that such other modifications and variations may be effected without departing from the spirit and scope of the present invention.

What is claimed is:

1. An excellence indicator system, comprising:
an excellence indicator system database, comprising information concerning resource allocation that is performed by a plurality of entities and indicia of performance of the plurality of entities;
a processing circuitry that is operable to perform selective processing of the information contained within the excellence indicator system database, the selective processing comprising integrating indicia of performance of at least one of the entities and resource allocation of the at least one of the entities; and
a user interface that allows interaction between a user and the excellence indicator system database;
the processing circuitry generates an analysis report that provides information including at least one of an assessment of financial well-being of the at least one entity, a relation of the at least one entity's performance based on costs incurred by the at least one entity, and an assessment of the allocation of resources by the at least one entity.

2. The excellence indicator system of claim 1, wherein the indicia of performance of the at least one of the entities comprises indicia of academic performance.

3. The excellence indicator system of claim 1, wherein the plurality of entities comprises at least one of a school district and a school campus.

4. The excellence indicator system of claim 1, further comprising a cognitive search engine; and
wherein the cognitive search engine operates cooperatively with the processing circuitry to perform the selective processing, the selective processing comprising identifying at least two comparable entities from the plurality of entities and performing comparative analysis of the at least two entities.

5. The excellence indicator system of claim 1, further comprising a cognitive search engine; and
wherein a user selects an entity from the plurality of entities for analysis;
the cognitive search engine operates cooperatively with the processing circuitry to perform the selective processing, the selective processing comprising identifying an entity comparable to the user-selected entity; and
the processing circuitry uses the user-selected entity and the cognitive search engine-identified entity are used for comparative analysis.

6. The excellence indicator system of claim 1, wherein the plurality of entities comprises a plurality of school districts and a plurality of school campuses;
the selective processing comprises identifying comparable school campuses when the comparable school campuses are located within comparable school districts;
the comparable school campuses being selected from the plurality of school campuses; and
the comparable school districts being selected from the plurality of school districts.

7. The excellence indicator system of claim 1, wherein the analysis report comprises at least one of a five-year trend chart and a graph.

8. The excellence indicator system of claim 1, wherein the selective processing performed by the processing circuitry comprises demographic analysis, resource allocation analysis, financial well-being analysis, and performance and costs analysis.

9. The excellence indicator system of claim 8, wherein the selective processing further comprises strength/weakness identification.

10. The excellence indicator system of claim 1, wherein the selective processing performed by the processing circuitry comprises identifying related cost factors.

11. The financial excellence indicator system of claim 10, wherein the identified related cost factors are further filtered based on a plurality of additional parameters, the plurality of additional parameters comprising geographical proximity.

12. The excellence indicator system of claim 1, further comprising a cognitive search engine; and
wherein the cognitive search engine operates cooperatively with the processing circuitry to perform selection of an entity by using a plurality of parameters, the plurality of parameters comprising size, socio-economic factors, taxable value factors, and trend factors.

13. An excellence indicator system, comprising:
a excellence indicator system database, comprising:
information concerning resource allocation from a plurality of entities, the information comprising a plurality of socio-economic factors, a plurality of taxable value factors, and a plurality of trending factors;
a processing circuitry that is operable to perform selective processing of information contained within the excellence indicator system database, the selective processing comprising integrating performance and resources of at least one entity within the plurality of entities; and
a user interface that allows interaction between a user and the financial excellence indicator system database;
wherein the processing circuitry generates an analysis report that provides information including at least one of an assessment of financial well-being of the at least one entity, a relation of the at least one entity's performance based on costs incurred by the at least one entity, and an assessment of the allocation of resources by the at least one entity;
the analysis report comprises a plurality of factors that are used by the user to assess the management of the at least one entity; and
the user performs data mining of at least one of the plurality of factors for further assessment of the management of the at least one entity.

14. The excellence indicator system of claim 14, wherein the plurality of entities comprises at least one of a school district and a school campus; and
the excellence indicator system database further comprises indicia of academic performance of the at least one entity.

15. A method to perform excellence indication, the method comprising:
selecting an entity to analyze, the entity being selected from a plurality of entities within a excellence indicator system database;
selecting an analysis parameter;
performing analysis of the selected entity using the selected analysis parameter; and
generating an analysis report;
wherein the analysis report provides information including at least one of an assessment of financial well-being of the entity, a relation of the entity's performance based on costs incurred by the entity, and an assessment of the allocation of resources by the entity.

16. The method of claim 15, further comprising selecting a comparable entity using a cognitive search engine to perform comparative analysis between the entity selected to be analyzed and the cognitive search engine-selected entity.

17. The method of claim 16, further comprising providing a parameter to the cognitive search engine to control the selection of the comparable entity using the cognitive search engine.

18. The method of claim 16, wherein the plurality of entities comprises a plurality of school districts and a plurality of school campuses; and
further comprising identifying comparable school campuses when the comparable school campuses are located within comparable school districts;
wherein the comparable school campuses being selected from the plurality of school campuses; and
the comparable school districts being selected from the plurality of school districts.

19. The method of claim 15, wherein the cognitive search engine operates cooperatively with a processing circuitry to perform selection of an entity by using a plurality of parameters, the plurality of parameters comprising size, socio-economic factors, taxable value factors, and trend factors.

20. The method of claim 15, further comprising performing at least one of demographic analysis, resource allocation analysis, financial well being analysis, and performance and costs analysis.
